(19) United States
(12) Patent Application Publication
(10) Pub. No.: US 2014/0282978 A1
(43) Pub. Date: Sep. 18, 2014

(54) METHOD AND APPARATUS FOR SECURE INTERACTION WITH A COMPUTER SERVICE PROVIDER

(71) Applicants: Sergio Demian LERNER, Ciudad de Buenos Aires (AR); Victor SUAREZ ROVERE, Ciudad de Buenos Aires (AR)

(72) Inventors: Sergio Demian LERNER, Ciudad de Buenos Aires (AR); Victor SUAREZ ROVERE, Ciudad de Buenos Aires (AR)

(21) Appl. No.: 14/215,787

(22) Filed: Mar. 17, 2014

Related U.S. Application Data
(60) Provisional application No. 61/802,370, filed on Mar. 15, 2013.
(60) Provisional application No. 61/895,958, filed on Oct. 25, 2013.

(51) Int. Cl. H04L 29/06

(52) U.S. Cl. CPC H04L 63/083
USPC 726/7

(57) ABSTRACT

A method for secure interaction with a website server capable of an authentication operation with a login operation checking a username and a password, is described. Standard web browsing environments are generally insecure and private information, such as passwords, are prone to theft. The proposed solution comprises securing the password used for the authentication in a trusted computing environment, such as a separate computer, without the need of revealing the password to a browser running in an untrusted computing environment, and basing the browsing on authentication data obtained as result of the login operation, that can be confirmed by the user in the trusted environment, prior of being performed.

### CROSS-REFERENCE TO RELATED APPLICATIONS

This application claims the priority and benefit of previously filed U.S. provisional applications No. 61/802,370 filed on Mar. 15, 2013 and No. 61/895,958 filed on Oct. 25, 2013, both of them in the names of Sergio Demian Lerner and Victor Manuel Suarez Rovere, each being herein entirely included by reference.

### BACKGROUND OF THE INVENTION

1. Field of the Invention

This invention relates to a method and apparatus for secure interaction with a computer service provider, and more particularly to secure systems where a user is authenticated prior to be given permissions to interact with the service provider.

2. Prior Related Art

Many types of devices for secure interaction with a computer service provider exists that allows a user to be authenticated prior to be given enough permissions to interact with the service provider for carrying secure operations. Several service providers authenticates the user by taking a username normally known and a secret password that the user has to recall. Typical cases of that prior systems are websites accessible by a computer (typically a desktop PC or mobile devices such as a smartphone) where the user logins to the system by entering in a page displayed by a web browser running the computer, his username and password. The user usually requires that interaction with the website being secure, for example in the case when the website is a home-banking service, in which case the most common solution is to build a secure channel like an HTTPS protocol for connecting the computer with the website server, point-to-point. The HTTPS protocol provides means for making the communication encrypted (so other computer systems like the ones in the middle routing the packets can't know all the communication details) and authenticated (so other computer systems can't silently behave as the authentic user or appear as the authentic server).

One limitation of the above systems is that different websites normally requires to be entered a username/password combination, that the website will check in his own records to authenticate the user. Since a user usually wants to access many websites in a secure way, the user has to know the secret password for each website. Since to achieve a moderate level of security the username may be shared across some websites but it's not wise to also share the secret passwords (a compromised website could allow access to unrelated websites), and since also for security reasons the passwords should be difficult to guess, in the end the user has the hard duty of remembering a set of many different of usually complex passwords. The complexity of this is ever increasing since, to further complicate matters they impose restriction on his selections, for example demanding longer passwords for coping with the increasing power of password-cracking machines.

The above problems call for ways of achieving some sort of password management so to alleviate the user of remembering the many passwords. A simple strategy of security-sensitive users is to keep a password list on paper, for example carried in a wallet. But the frequent need for changing passwords or the hardly practical encryption makes this strategy rather difficult, calling for a digital solution. There exist for that purpose some systems that assists in the password management in a digital way (usually software called “password managers”) but anyways they left many security issues unsolved.

As an example of a password manager, there are some that are conveniently integrated into a web-browser that automatically recalls and suggest the password whenever needed in a browsing session. There are also some “portable” versions that allows being executed from a USB flash drive, so the user can carry the software with the associated password database in a mobile fashion.

Regardless the convenience inherent in those portable password managers, many limitations remains. The main limitation is related to the security of the platform where the password manager runs: if the platform is not secure enough, all the security that the password manager promises to bring is masked by the insecurity in the platform itself where the password manager runs. For example, in the portable browser with integrated password manager case, whenever a user transporting it approaches a computer not of his control (such as in a cybercafe), the security of the system is unknown and the user may opt to just avoid to use the system for the involved security risk, losing all the supposed portability benefits. Locking the user to known systems is too inconvenient and anyways of little help, since it's widely known the ever increasing kinds of malware that everyday exploits new vulnerabilities of the target systems, so since prior password managers in some time put master secrets and other data unencrypted in RAM, if malware can access the data the results with those prior systems can be catastrophic.

It is considered to use the invention for solving problems found on sites that require authentication such as unique passwords (the most common way), but today the passwords must be long and thus complex to remember, and he user cannot ensure that the session won't last without his consent, and the user cannot know if an active attacker is using his session jointly with him for other purposes. On prior systems, there is no secure confirmation granularity of the actions in face of an active attacker, an active attacker can steal the session once it was authenticated and the user cannot be sure to whom the information is sent. Normally the sites have their own authentication system, basically offering two options:

1) To use the same password in various sites, but security levels often are not enough since by having its own system defines its needs (password kind), or ask periodic changes (ruining the strategy). There's other security problem: the attacker can hack a site and enter other site.
2) To have various keys, impossible or remember.

There exist other passwords managers but they don't automate the password changes, neither test access periodically, and can be trojans, or run in an infected PC. In the case the password managers are local (such as running in a PC), they don't support an active attacker, or are not portable. Instead if they're portable and integrated, they typically don't support an active attacker and can be uncomfortable in comparison with a PC. If the case that password manager runs in the cloud, if information gets decrypted in the server, there's greater problem than with the local case (since the server is a more attractive target), or can be wrong regarding the protocol (for example using a library with a security hole), or other internal attacks if the server is used as encrypted backup. If the password manager is web-based, it's exposed to phishing. In the case the password manager being portable (such as the password manager program and passwords stored in a pendrive), there is a need to trust the machine where it's run, or in other case everything can be stolen. If implemented by means not accessible to the PC, an attacker can steal the password when you input it (such as for example in a notebook) if it isn't encrypted, or it's insecure.

There are existing authentication implementations utilizing “discardable” passwords, for example received from a second channel or two-factor authentication. Problems with that existing implementations are that: both devices can be hacked, or it isn't useful in automatic fashion for sites already designed for using unique passwords, or the added issue of cost of second channel, or the risk that the second channel is not available, and overall it's needed a device that (in general) is expensive and to be charged frequently. Further, an active attacker can steal the session as an additional problem of those other implementations once it was authenticated.

Other possible options for authentication is by using schemes with the data used for authentication generated on-the-fly near to the user, such as Time-based One-Time Password (TOTP), but there remains some problems, including the case of both devices can be hacked, and it's not useful to be used in automatic fashion for sites already designed by unique passwords: for TOTP you need special support in the server, a support not found or configured on the majority of servers since username combined with static passwords is the current widespread authentication method for websites, and the proposed invention can work for that widespread servers, unmodified.

As an additional considered problem, there is the case of an active attacker that can steal the session once it was authenticated.

### SUMMARY OF THE INVENTION

Accordingly, it is a principal object of the invention to provide a method and apparatus for secure interaction with a computer service provider that offers a very high level of security and at the same time is low cost and highly convenient to use.

The foregoing is accomplished in the preferred embodiments by making to work, in combination, an independent computing platform with a standard system such as a PC or tablet for interacting with a server by using known and widely deployed protocols, in a way that selected secure operations are carried in the independent computing platform (optionally by the use of an integrated user interface) without leaking sensitive information but at the same time taking advantage of powerful computing resources that the standard system may have (such as a big screen and high-speed internet connection for retrieving and displaying the results), so permitting overall higher secure operations without demanding the same level of security on the standard platform.

The very high level of security is achieved by configuring the independent computing platform handling the most sensitive secure operations, simultaneously achieving a very low attack surface since being architecturally small and with ability of controlling the software running on it, for example by not allowing the execution of non-authenticated software (as many platforms like PC and smartphones allow), and since it doesn't need to run big software systems like operating systems or browsers for PC that normally are built from several millions of lines of code and the associated security issues potential. It is low cost since, in the preferred embodiments, the independent computing platform can be implemented with low-cost microcontrollers, and at the same time is highly convenient to use since it can be small enough to be conveniently transportable as part of a key-chain. The convenience is further improved since the independent computing platform normally works in combination to a system an regarded as insecure (such as a PC or a tablet), so taking advantage of their powerful user interfaces and other resources like computing power, big memory, network resources, and the like so complementing the resources that the independent computer platform lacks for achieving its small size, mobility and power requirements, but anyways using both in combination the user experience is very transparent but much more secure.

On the inputs of the user interface of the secure platform can be a biometric sensor, such as a fingerprint reader, which allows fast confirmation of operations combined with user authentication.

A set of objects and advantages of the preferred modes of the invention are listed as follows:
a) To provide a system that eliminates or significantly lowers the requirement of trusting the standard platform where a web browser runs.
b) To provide a system adapted to standard and widely deployed protocol such the HTTP protocol as used for internet navigation.
c) To provide a system that can securely track open login sessions and control their closing.
d) To provide a system that can control and filter unwanted operations.
e) To provide a system that allows the user to know to which server his operations are being delivered and also to trust the data sent as the operation parameters, and to know when the operation is requested.
f) To provide a system that allows the user comply with the need imposed by some servers of frequently requiring changing passwords, or to easily make password changes to many selected sites in order to reduce the temporal window of repeated password use.
g) To provide a system that allows the user to easily and frequently test which passwords of his list are still valid, so to detect an unwanted password change.
h) To provide a system that is resistant to keylogger and spyware malwares.
i) To provide a system that is portable, small, low cost, low power.
j) To provide a system where the password database is not centralized for unrelated users.
k) To provide a system that is resistant to phishing attacks for selected operations.
l) To provide a system that allows user to manage different passwords for each site.
m) To provide a system that can store secrets as passwords, credit card numbers, cookies used for authentication and other authentication tokens, in a secure way, without revealing them to a browser running in the standard platform.
n) To provide a system that is resistant to the secure platform being lost.
o) To provide a system that can easily manage long passwords.
p) To provide a system that can filter and block unwanted operations and to log data associated with the operation.
q) To provide a system that can white-list some operation for being automatically confirmed and automatize the parameters setting of some known operations.
r) To provide a system that, with an standard platform and the independent secure platform used in combination, allows the system to be secure enough for not needing a third platform for communicating secrets to the server.
s) To provide a system that can securely show the results of some specific operations.
t) To provide a system that makes infeasible to continue to use of open sessions by unauthorized users, by performing the simple operation of disconnecting the independent system from the standard system.
u) To provide a system in which there's no need to remember the passwords.
v) To provide a system that resist active attack to the PC.
w) To provide a system that doesn't reveal the passwords. You know to whom you are sending the sensitive data.
x) To provide a system that doesn't require a secondary channel.
y) To provide a system that increases the security by reduction of the temporal use window of each password.
z) To provide a system that provides cost reduction since it doesn't require to pay secondary channel, doesn't require to acquire an expensive device such as an smartphone.
aa) To provide a system in which the user can ensure that the session won't last without its consent, when he wish to close it.
bb) To provide a system in which the user can know if an active attacker is using his session jointly with him with other purposes.
cc) To provide a system in which there exists granularity of secure confirmation of the actions in face of an active attacker.
dd) To provide a system in which there exists the possibility of obtaining secure receipts with granularity for specific actions.
ee) To provide a system in which less resources are generally used (compared for example with a smartphone), and it's possibly implemented as a portable device, of very low power and with a low attack surface.

The present invention can provide a solution to the security problem and the authentication based in a device that manages the communication part that requires high security and delegates the lower security part, over a single communication session with protocols standard and preexistent to this solution and conventional passwords.

The invention can also be used in Single-Sign-On systems, such as Kerberos, where an authentication server provides an authentication token that must be temporarily stored in the client computer, to be sent to a second server that provide service and that are configured to accept these tokens as proof of granted permission for the service, at a later time. In this case, the independent secure platform stores the authentication token and provides the client PC a fake token. When the token is required to authenticate with the second server, the secure platform retrieve the authentic token and replace the fake token with the authentic token, in a way that the PC is unable to access the authentic tokens though-all the mentioned process, and in a way that is transparent to the Kerberos client software module.

A possible way of using the device is as follows:

The user wishes to access a site protected by password from a PC in a cybercafe. The user presses both buttons to momentarily activate the device and put it out of Standby. The device shows a screen for inputting a numeric PIN. The user inputs the PIN. The UI device accepts the correct PIN and emits an acceptance sound. The user separates the devices “UI” from “Dock” and connects the Dock part to the cybercafe PC. Automatically the PC recognizes the device as a Mass Storage Device (MSD) and the user runs a special browse hosted in the MSD. The browser presents a home page with a list of possible web sites to which the user can access. The user selects the desired site and it appears in the UI device display the domain and company number indicated in the server certificate. A sound alarm indicates to the user that he should accept or deny the connection. The user accepts by pressing an UI button. Automatically the browser enters the site in a secure way, without showing the password input screen. When the user finishes work, closes his session from the PC and the UI device point outs that this happened if the user removes the Dock device in an ill-timed fashion no session can send more data to the server that were connected by means of the UI device. The user downloads from Internet a browser specially modified to allow to function in combination with the Dock and UI devices. The user executes such browser. A considered way of achieving the input of the PIN, is by means of the gestural human-machine communication that is described later, or the combination of circular movements (detected by the accelerometer) and button pressing to fix digits.

Further object and advantages of the invention will become apparent from the following detailed description of preferred embodiments of the invention when taken in conjunction with the appended drawings.

### BRIEF DESCRIPTION OF THE DRAWINGS

FIG. 1 shows a flowchart for setting up the system and optionally presenting a menu of sites to login

FIG. 2 shows a flowchart for processing HTTP requests and deciding the destination of the requests by a multiplexer/router

FIG. 3 shows a flowchart for processing request in the dock

FIG. 4 shows a flowchart for sending request to internet and processing the response in the dock

FIG. 5 shows a flowchart for optionally requesting user attention and possibly user confirmation or other interaction

FIG. 6 shows a flowchart for deciding when to make SSL/TLS re-negotiations to improve the overall performance.

FIG. 7 shows a flowchart for a login attempt in a manual fashion (for example Browser triggered)

FIG. 8 shows a flowchart for the automatic part of the login

FIG. 9 shows a flowchart for a logout attempt in a manual fashion (for example Browser triggered)

FIG. 10 shows a flowchart for handling the response of a logout

FIG. 11 shows a flowchart for handling commands (for example executing any action triggered by the Dock)

FIG. 12 shows a flowchart for an automatic logout

FIG. 13 shows a flowchart for the filling of the password fields in logins or other actions which require secret passwords.

FIG. 14 shows a flowchart for the transformation of a request based on a Transformation Record.

FIG. 15 shows a flowchart for the handling of responses to requests made by the Dock.

FIG. 16 shows the continuation of the flowchart started in FIG. 15.

FIG. 17 shows the flowchart for the handling of user notifications trigger by responses received from the remote website.

FIG. 18 shows a flowchart for accessing the master secret if a correct PIN is entered.

FIG. 19 shows a flowchart for show menu process.

FIG. 20 shows a flowchart for the construction, presentation and handling of a Menu which contains a user selected actions.

FIG. 21 shows a ER-like diagram of the data entities (Records) accessible to the Dock.

FIG. 22 shows a ER-like diagram of the data entities (Records) accessible to the UI.

FIG. 23 shows core operation of the invention

FIG. 24 shows additional operation of the invention

FIG. 25 shows a flowchart for the derivations of passwords using stored secrets.

FIG. 26 shows a flowchart for the handling of secure connections after no more data is expected to be received from the connection.

FIG. 27 shows a hardware architecture for an implementation of the “Dock” module

FIG. 28 shows a hardware architecture for an implementation of the “UI” module

FIG. 29 shows a hardware architecture for an implementation for the “Standard Platform” module

FIG. 30 shows a hardware architecture for an implementation of a combined “Dock” and “UI” module

FIG. 31 shows a hardware architecture for an implementation of an integrated “Mobile Secure Platform”

FIG. 32 shows a hardware architecture for an alternative implementation of the Dock module in the form of a server.

FIG. 33 shows a hardware architecture for an alternative implementation using a tamper-resistant module accessible through the standard platform.

FIG. 34 shows a hardware architecture for an alternative implementation using an HDMI monitor as output and HDMI switch.

FIG. 35 shows a hardware architecture for an implementation of an example secure computing platform based on UI and a Dock

FIG. 36 shows a hardware architecture for an implementation of an example secure computing platform based on a single microprocessor

FIG. 37 shows a hardware architecture for a standard platform such as a PC or a mobile device

FIG. 38 shows a basic diagram of the software modules when the secure environment is implemented as a Dock and a UI.

FIG. 39 shows a detailed diagram of the software modules present in most embodiments.

FIG. 40 shows an alternate embodiment flowchart for processing request in the dock

FIG. 41 shows an alternate embodiment flowchart for sending request to internet and processing the response in the dock

FIG. 42 shows an alternate embodiment flowchart for a login attempt

FIG. 43 shows an alternate embodiment flowchart for a manual logout attempt

FIG. 44 shows an alternate embodiment flowchart for a command attempt

FIG. 45 shows an alternate embodiment flowchart for a logout attempt

FIG. 46 shows an alternate embodiment flowchart for filling a request

FIG. 47 shows an alternate embodiment flowchart for transforming the body or header of a request

FIG. 48 shows an alternate embodiment flowchart for processing the response sent by the website in Dock

FIG. 49 shows the continuation of FIG. 48

FIG. 50 shows an alternate embodiment flowchart optionally user notification, requesting user attention and possibly user confirmation or other interaction

FIG. 51 shows an alternate embodiment flowchart of obtaining the main secret and asking the user for a PIN if necessary.

FIG. 52 shows an alternate embodiment flowchart for inserting the secure authentications in the HTTP header associated with found locators and removing such locators

FIG. 53 shows an alternate embodiment flowchart for showing a menu listing login, logout and other command actions and performing the action associated with a selected item

### DETAILED DESCRIPTION OF PREFERRED EMBODIMENTS

In the following description, the system involving two computers, each controlling its own User Interface, will be described as a preferred embodiment. The independent platform comprises a module called “Dock” (shown in FIG. 27) and a module called “UI” (shown in FIG. 28). The UI module includes a main 32-bit microcontroller, which have integrated: RAM and FLASH memories, crypto accelerator with random number generator, battery operated real-time clock, a 4-pin female connector for serial communications and power. The UI module microcontroller also has interfaces for controlling a set of connected devices including: an LCD display, a wireless module BlueTooth 4.0 (BLE), touch buttons, battery monitor chip, sound output. The UI module also has a battery rechargeable by the 4-pin female connector. The wireless module includes an integrated microcontroller capable of communicating with the main microcontroller of the UI module in serial and by using DMA and interrupts of the main microcontroller.

The “Dock” module has a 4-pin male connector for powering and recharging the battery of the UI module and also for high-speed communications. The Dock also has a 32-bit microcontroller with low-power modes and integrating RAM and FLASH memories, crypto accelerator with random number generator, USB high-speed interface, DMA, interrupt controller that automatically puts the device out of stand-by modes. The Dock microcontroller also has interfaces for controlling a set of connected devices including: SD flash memory, a module BlueTooth 4.0 (BLE). The dock also has an USB standard-A plug connected to the high-speed USB interface.

The wireless module of the UI module has enough RAM for using a portion as a communication buffer large enough to communicate with another microcontroller in a way that the other microcontroller can be operated in a low duty activity to save power, for example by exchanging data by DMA or by generating interrupts in the other microcontroller when packets of data get transmitted by the wireless module. The low duty is low in the sense of achieving a similar power consumption as of the wireless module needs to transmit packets the size of average HTTP headers.

The dock module, UI module and the standard platform are all networked, preferably by secure channels.

It is considered that the secure channel is monitored for its state for taking decisions based on the change if the state. For example, if the Dock detects that the channel communication is interrupted, it can stop sending secure authenticators to the remote website and prevent the use of cached private data. Also the dock can, if configured, logout immediately from any website currently logged in to prevent another user for continuing browsing over the opened sessions.

Reciprocally if the UI detects that the strength of the secure channel wireless signal has dropped below a threshold, the UI can play a sound alarm indicating the user may be forgetting the Dock connected while going out. Also upon a signal drop, and after the signal has been reestablished, the UI can request re-confirmation of logins that were previously confirmed and the user accepted not to be asked for confirmation again.

The “PC” term is representative of the standard platform (shown in FIG. 37). There's a software module (the M/R module) for multiplexing and routing connections between the PC (shown in M104), the Dock and the server, the server typically being in the Internet and serving a website by means of HTTP/HTTPS/TCP/TLS/WS/WSS (Secure WebSockets)/FTP/FTPS (FTP over TLS)/WAP/SSH protocols. It is considered not only the HTTPS protocol that combines the HTTP protocol with the SSL/TLS protocol, but other combinations like used in the SPDY protocol usually used for faster webpage retrieval. The dock can act as an USB flash drive by using the connected SD memory as flash drive storage, and the user can conveniently store there an specially adapted web browser software and/or the M/R module. The web browser is adapted to run the M/R module, channeling outbound and inbound connections through this module, and to communicate with the dock by means of the USB interface. Also the USB flash drive holds a setup application that configures a browser previously installed in the PC to work successfully with the M/R module. The browser (either per-installed or run directly on the USB Flash drive) has the ability of showing a menu provided by the Dock, which lists actions for predefined sites that may include the login action. The same menu can be shown on the UI (rendered specifically to allow easy reading on the UI display, and easy selection of an item using the UI input controls). As a normal browser is operated by a user, it normally opens TCP connections to remote sites, does TLS handshaking if necessary, and transmits HTTP/HTTPS requests. Also the browser may open TCP connections for WS/WSS/FTP/FTPS protocols or even raw TCP channels. The M/R module job is to intercept these connections and decide whether data should go to the Dock, or to the Internet, and the same for incoming data. There are four ways the M/R module can operate to fulfill its job:
1. The R/T module is an application which provides a HTTP/FTP/WS proxy server which runs in the PC. All connections to remote websites will pass though this proxy. To do that, the browser proxy configuration is modified. All major PC browsers support proxy configuration. The user is instructed to use HTTP protocol instead HTTPS protocol for secure sites which normally communicate over HTTPS. The M/R module accepts incoming connections and decides, based on user configuration, if:
2. A new unsecured connection will be established with the remote server to forward incoming/received data.
3. A new secure connection (but without client authentication) will be established with the remote server to forward/receive data (with transparent encryption/decryption)
4. The data will be forwarded to the Dock, where a secure connection will be established with the remote server (using again the M/R as a gateway), and client authentication tokens will be sent along with the data. The Dock may also refuse to perform the secure connection itself and the M/R module will fall back on option A or B.
5. The M/R module is an application which provides only HTTPS/FTPS/WSS proxy services, running on the PC. The browser is configured to forward all secure connections to the M/R module, and connect directly with the remote websites for the rest. Also the browser configuration is modified by adding a new M/R Root Certificate (MR-ROOT-CERT) for which the M/R has the private signing key, so the M/R module acts as a certificate authority. The M/R module provides the browser correct certificates (in the chain of trust of the MR-ROOT-CERT) for the remote website that are be accepted by the browser. These certificates can be either per-computed or built on-the-fly. The M/R module decrypts the data that is being sent by the browser and sends this data to the Dock, where eventually a new secure connection will be created (or a per-existent open connection will be reused) to talk to the remote website (using the M/R module as gateway).
6. The M/R module is an application which provides only HTTPS/FTPS/WSS proxy services, running on the PC. No root certificate is installed. The M/R module provides fake certificates to the browser, and the browser will alert the user on these abnormal behaviors. The user agrees to accept the fake certificates, and all information is processes as in the previous option (2).
7. The browser software is modified not to actually open TCP connections for the HTTPS requests, but the requests are sent in clear-text to the M/R module, which is statically or dynamically linked with the browser application. The same is done for data packets of FTPS and WSS connections: a request containing the authentication part of the session (AUTH in case of FTPS or cookies in case of WSS) is previously sent to the M/R to decide whether the connection should be opened in the M/R module or the Dock (using the M/R itself as gateway).

Possible implementation is that the Dock presents to the PC as a network adapter and internally runs the proxy server. The advantage is that it does not require installing new software applications on the PC.

The Dock handles the client authentication of the sessions, such as providing a user and a password, and if desired handles the authentication tokens received by the remote website (such as cookies or other known ways of keeping track of web sessions). This authentication tokens will be referred as Secure Authenticators or SAs. So it is considered that the dock doesn't reveal the SAs in plain text to the PC, and instead SAs are transformed by the Dock in data items that are defined as Locators. Locators can also be cookies or other ways of tracking web session, but locators are meaningless for the website, since they are created and handled by the Dock, in the said embodiment, the Dock must be always present to allow the Logic session to continue, since websites require SAs to proceed, and those SAs are not available to the browser. If it's not desired to keep SAs protected, then the SAs are be revealed as plain text to the PC.

To send information such as SAs or Locators to the Browser, several options are considered:
a) The Dock is configured as an HTTP gateway. The user first connects to the website using HTTP and this connection is trapped by the Dock. The Dock forwards this requirement by HTTPS to the website. Then the Dock received an HTTP response from the website and forwards this response to the Browser over the unencrypted connection, including the SAs, but adds a redirection to the HTTPS webpage, so that the Browser automatically continues the connection by connecting directly to the website over HTTPS.
b) The user can browse the website using HTTPS and the Dock can be configured to be and HTTP/HTTPS proxy, rewriting any HTTPS URL to the website present in request and responses to its HTTP form, so the browser cannot detect that the session is being tunneled by HTTPS.
c) SAS, Locators (e.g. cookies) can be received by the browser from an HTTP header built or forwarded by the Dock. In case of the SAs, they can be received directly from the website.
d) SAs can be sent to the browser by means of a browser plug-in that communicates with the Dock.
e) SAs can be sent to the browser by means of JavaScript code executed from a file provided by the Dock or stored on the file system, for example, a Gracemonkey script.
f) SAs can be inserted to the browser by using an API provided by the browser or by the operating system, for example, for persistent cookies.

For any of the options previously described, M/R chooses where to forward the requests/packets based on the protocol, the destination address, other fields of the request header and the state of the state-full connections. In a standard mode of operation, any original HTTPS/TLS/WSS request that is not part of a session will be forwarded directly to the destination website. An authenticated session is identified by the presence of one or more string tokens which called Locators. Data sent over originally non-secure protocols (such as HTTP/TCP/WS) are also normally forwarded to the remote websites without begin redirected. Requests that were created by browsing the Menu provided by the Dock are always redirected to the Dock. In case the M/R module is a proxy, the multiplexer will generally route the data packets to the Dock until client authentication is provided by the browser (header/name/value pairs of HTTP or AUTH in FTPS). All routing rules in the M/R module are user-configurable.

After Dock has opened a secure connection to a remote website (using the M/R module as gateway) and has sent authentication information it may perform a rekey of the TLS protocol using ChangeCipherSpec commands and pass the cryptographic keys of the outbound stream of the connection to the M/R module. The M/R will now control the outbound stream and then the following packets are routed by the M/R module directly to the remote website. The dock is capable of creating its own HTTP requests and send them to the Internet using the M/R module as gateway. In an alternate operation mode, which preserves user's privacy better, the system supports accepting manual logins by the user (and not using a Menu provided by the Dock). In this mode the M/R module forward every request the Dock, where it is be analyzed to check if the request is a Login, or any other action that requires a previous Login in the remote website, and inform the M/R module which routing will take place. This prevents the PC from accessing the lists of the websites for which the Dock is configured to provide secure authentication for.

For each request generated by the browser, a filter is evaluated so to avoid sending unneeded request to the dock. The main advantage of this is to alleviate the use of resources on the dock. For the requests sent to the Dock, the dock handles the client authentication of the sessions, such as providing a user and a password, and handling the authentication tokens received by the remote website (such as cookies or other known ways of keeping track of web sessions). This authentication tokens will be referred as Secure Authenticators or SAs, when they are recognized as such in the Dock. In this embodiment the dock doesn't reveal the SAs in plain text to the PC, instead, SAs are transformed in the dock to Locators (in other embodiments the SAs can be revealed as plain text to the PC). Locators can be used to obtain the corresponding SAs in several ways. The result of this process is that each Session Authenticator is a function of a Locator, since each locator unequivocally maps to a Session authenticator.

These are possibilities for the mapping function:
a) Locators can be used to look-up corresponding Secure Authenticators in tables. This is a function from an index space to the space of recorded SAs.
b) Locators can be an encrypted and MAC authenticated version of the Secure Authenticators. SAs are obtained using the decryption function.
c) Each Locator can be built as a hash of the corresponding SA. The function is a lookup in an appropriate data structure for storing the relation.

The PC should never see a SA in a HTTP response, and the remote website should never receive a Locator in a request. This way the PC cannot authenticate directly to the server so, even if the PC has malware, the malware cannot impersonate the user, no matter how compromised is the PC. Nevertheless, the malware could perform any action in behalf of the user, for which the user has not specified a secure confirmation, during the time the session is active.

Login operations are detected and when required, are sent to the dock so to begin the login operation, which provides the corresponding passwords and optionally the username and the login request is sent the to the server, which, if access is granted, will return one or more Secure Authenticators in the response. Normal responses that reach the browser from the dock or from the internet via M/R module are rendered by the browser. The dock may nevertheless block or transform responses.

A selected subset of “secure” actions (also called operations) in the web browser can be confirmed in the UI prior to being sent. The UI can be trusted by the user since the dock and UI modules are highly secure. This way, no matter how compromised is the PC, what the user sees in the UI module is representation of the operation being carried. It's thus infeasible for malware on the PC to alter the information shown to user in the UI for the selected subset of secure operations. For example, for a login operation, the dock/UI modules known which server is to be connected to so the user can confirm if he wants to login in that server, as shown on the UI, regardless of what is displayed on the PC screen. Connections originating in the dock are done point-to-point (using the PC as a gateway) to the required server by means of the TLS/HTTPS protocols and server certificates are checked, including the test for revoked certificates.

To prevent a malware on the PC performing an operation regarded as secure by the user, for example a payment, the user can set a filter for forcing confirmation on those kinds of operations. If an unwanted operation like a payment unexpectedly appears on the UI (for example, being triggered by a malware), the user can just not accept it. During confirmation, the user has access to the details of the transaction prior to acceptance in a secure way since the UI module that has complete control of the display and input controls.

The dock can analyze the packets in order to delegate some networks operations to the PC. For example, if the user operation is to upload a file in an established login session, the dock can send the request header, put the required authentication data representative of the session, send the modified header and once the header is sent, the PC can continue uploading the file. For obstructing the PC to decrypt the sent packets, a session renegotiation is carried before allowing the PC uploading the file. The dock can do the renegotiation and send to the PC (from the obtained renegotiated SSL/TLS session) the required keys for uploading data. That way, the PC can't know the parameters used for encrypting the request headers. This saves a lot of communication resources and other resources from the dock when uploading the file.

In a similar fashion, to download a file the response can be checked by the dock to look for sensitive authenticated data, if present a renegotiation can be carried so the PC can download the rest of the data with the renegotiated keys that are needed for downloading data. The condition for renegotiation can be based also on packet size, so small request/response can be managed entirely in the dock for avoiding the cost of a renegotiation. It is also considered not only file uploading/downloading but in a similar fashion, data streaming such as video data. For example the downloading of video data can be offloaded to the browser by a renegotiation operation as described.

The Dock microcontroller provides write-protection and read-write protections for a parts of the storage served to the PC as a USB Flash Drive. The Dock lift the protection barrier when provided a secret password either from the PC user interface or from the UI module.

A way of implementing Stream Multiplexing System (also called M/R module) is by a system that let both the PC and the Dock to connect full-duplex to the Internet. The system allows each connection to be treated as two separate half-duplex streams. So multiplexing system allows to redirect any of these streams of an existing connection from the Dock to the PC.

A Standard Platform can be a PC, Tablet, smartphone or similar systems. Usually has an user interface and networking.

Locators can be implemented as data fields that are sent to the PC by the Dock in order to associate a certain web page with a previously negotiated authentication context. Locators can be cookies, hidden fields in HTML forms, URLs parts, URL query variables, or any means of storing temporary information regarding authentication associated with a web page.

A Session-Authenticator (SA) can be implemented as a cookie, hidden field in HTML forms, a part of an URL path, an URL query variable, or other data token that was provided by a remote web site through a secure communication channel that is recognized by the Dock as a provider of client credentials required for future authentication against the same web site or another server affiliated with the original website.

Other possible embodiment is considered as follows: There are two kind of HTTP requests sent by the Dock to the remote Website: HTTP requests that are transformations of other HTTP requests originating from the PC (called manual actions) or requests that are built entirely by the UI/Dock (called Automatic Actions). Both type of actions can be self-triggered or triggered by the user using the Web browser, by visiting URLs.

Operation

Regarding FIG. 23:

Step S01A is for arranging a first computing environment.

Step S01B is for configuring a second computing environment for running a browser.

Step S01C is for deciding whether to perform the login operation.

Step S01D is for obtaining the password.

Step S01E is for inserting the password into an HTTP request.

Step S01F is for checking the website server's certificate.

Step S01G is for establishing a login session.

Step S01H is for securing the password for not revealing it to the browser.

Step S01I is for browsing the established login session.

Regarding FIG. 24:

Step S02A is for transforming the Secure Authenticator in the Dock to obtain a Locator.

Step S02B is for securing the Secure Authenticator for not revealing it to the PC.

Step S02C is for sending the Locator to the browser.

Step S02D is for carrying the browsing based on the Locators.

Step S02E is for obtaining in Dock the Secure Authenticator associated to the Locator received from browser.

Step S02F is for inserting the Secure Authenticator in a request header to be sent to the website.

Regarding FIG. 1 to FIG. 26:

In step 0110 the Network is configured so the UI can communicate with the Dock through a secure channel (encrypted and authenticated).

In step 0120 the PC is configured to run the Stream Multiplexing System.

In step 0130 The PC Browser application is read (preferably from a secure source such as a read-only pen-drive, the Dock or a secure site on the Internet). Afterward the PC Browser application is launched.

In step 0140 a decision is made regarding the visualization or not of the Command/Login Menu. The decision is based on the Configuration stored in the Dock and may also be based on the identification of the PC running the PC Browser.

In step 0150 the Menu is build and shown to the user as a HTML rendered page in a tab of the PC Browser.

In step 0160 the PC Browser starts normally and begins to process user interactions and construct HTTP/HTTPS request.

In step 0210 The PC browser loops waiting for user Interaction or automatic triggering of HTTP/HTTPS requests.

In step 0220 the PC Browser creates a new request HTTP/HTTPS request.

In step 0230 a decision is made regarding the forwarding of the request to the Dock or to the Internet. If the request contains well-formed Locators then the request is redirected to the Dock. If the request is HTTPS and matches preconfigured URL patterns, it is also redirected to the Dock. Otherwise the request is handled normally.

In step 0240 the header of the request is sent to the Dock. The Dock is able to read the request header and recover the plaintext.

In step 0250 the Dock processes the request in order to analyze if it is associated or will be associated with a secure operation.

In step 0260 the request is sent to the Internet without going through the multiplexing system.

In step 0270 the response is received normally from the Internet without going through the multiplexing system.

In step 0305 the request header is analyzed by the Dock searching for well-formed Locators. To detect locators, the remote website is identified by the destination URL. Afterward, the Active Session Records are scanned. For each Active Session record, the associated Login Record is fetched and the “SA/Loc replacement script” is executed. The “SA/Loc replacement script” may request that the PC sends the remaining part of the request (the body) to the Dock if this is required to find the locators. The script then removes the locators from the request and inserts associated SAs, optionally using the “SAs/LIDs” and “Locators/LIDs” tables present in the Active Session Record. If one script succeeds, the remaining scripts are not executed, and the Login Record and Active Session Records associated are selected. To allow cross-site authentication, entries of the “Locators/LIDs” field can be marked as global. All global locators are searched and replaced by the corresponding SAs, disregarding the Active Session Record that has generated them. For example, to allow OpenID integration, the OpenID Request parameters contents are considered SAs (openid.mode, openid.identity, openid.session_type, openid, nonce, openid.sig, openid_assoc_handle, etc.) and replaced by locators. These locators are marked as global. Also the Website Record and Login Records provide external authentication options to provide a narrower cross-site authentication bridge, by passing SAs from one to the other transparently.

In step 0320 the header is analyzed searching for Website records or Login records. If a Login Record was selected in step 0305 then this Login Record is used. From the Login record, the associated Website record can be retrieved. Afterward, the flow continues using this record. If no Login Record was selected in step 0305, a Website record associated with this request is searched. Website records specify the Website URL, which can match top level domains, sub-domains or an URL path in a website. A website record is found if the requested URL matches the Website URL pattern. If a Website record is found, the exact action to perform (login, logout, change password, etc.) must be detected. This detection is done by executing pattern detection scripts associated with each action. The “Detection pattern/script” field of the Action Record specifies the matching detection function. The detection script may look for cookies, fields, the URL, or any other information contained in the request, in order to decide to execute the associated action. Also the script may request the PC to send more data of the HTTP request (possibly including the body), in order to search in this part. Actions that require the user to be first logged in the website are marked by the “Require login” flag. If the session-authenticators were not present, the “Auto Login” procedure is performed first, and then the flow continues executing the detected action. A special case is the Logout action, for which no login is attempted if no session-authenticators were found.

In step 0325 a decision is made regarding that the found action is a Login Request Action. If Yes, then the manual login attempt procedure is executed in step 0330. If No, then the flow continues in step 0325.

In step 0330 the manual login attempt procedure is executed. This procedure sends a request for login to the remote website and stores the Session-Authenticators received in response.

In step 0335 a decision is made regarding that the found action is a Logout Request Action for the logout operation. If Yes, then the “Manual Logout Attempt” procedure is executed in step 0340. If not, the flow continues in step 0335.

In step 0340 the procedure of “Manual Logout Attempt” procedure is executed. This procedure ensures that the HTTPS Logout request is sent to the remote website in a secure way, checks for a positive response and destroy all Locators/Session-Authenticators associated with the Login Record.

In step 0345 a decision is made regarding if another action was found or not. If Yes, then a “Auto Login” is executed in 0350. If No, then this sub-process finishes in step 0370.

In step 0350 an Auto Login Attempt is executed. This procedure ensures that the user has logged in into the website before an additional action that requires login is executed. The procedure uses the Website and Login Records to build the login request. This is done by the process “Execute Action” depicted in FIG. 11, for the Login Action Record.

In step 0355 any other predefined action is performed, which may include confirmation and/or logging. Other actions may also request passwords from the UI, similar to a Login. For example, a “Change Password” action may require the previous password to be sent along the new password. Scripts may also generate new random or pseudo-random passwords and update the secrets stored in the UI. The UI may be configured to require confirmation if secrets are to be updated.

In step 0360 the request is performed to the remote website.

In step 0370 the sub-process is finished and the request is not handled by the Dock. Instead, the PC handles this request.

In step 0410 the user may be notified by a confirmation messages describing the current request and the flow may be paused until the user confirms or rejects the transmission of the request to the Internet.

In step 0420 the request is sent to the Internet by the PC or by the Dock, depending on security and performance considerations.

In step 0430 a portion of the HTML response is received by the Dock and the Dock decides if the Dock will receive more portions of the response or not. The Dock may decide not to receive more parts itself and so inform the multiplexer to allow the PC to receive the remaining parts directly from the Internet. The parts of the HTML response previously received by the Dock will be sent to the PC so it can reconstruct the whole HTML response. In case of a Login, the response after a login operation carries the secure authenticators (SA) such as cookies. In the case it is desired to protects the SAs, then SAs are privately stored in the Dock and so the HTTP response cannot be handled entirely by the browser, and that's why the Dock is the first to receive the HTTP response. In case it's not desired that the SAs are protected, then the HTTP response of an HTTP login request can be handled entirely by the Browser. This can be done either by renegotiation the SSL/TLS connection keys or by establishing a new connection from the Browser to the website. Since some browsers are susceptible to attacks based on the truncation of the TLS stream, the Dock can increase the security on this regard. When a login is taking place, the Dock can be configured not to derive the receiving of the HTTP response to the browser until all the HTTP header has been received. Also in cases where a website or an specific webpage security may be compromised by an attacker who truncates the web pages by interrupting the connection, the Dock may be configured to never derive the receiving of the HTTP response to the browser for those websites.

In step 0510 a decision is made regarding the need to alert the user of a request that requires more security. If Yes, then a message will be displayed to the user in step 0520. If No, then nothing happens.

In step 0520 a message is shown to the user in the UI. The message is a description of the request. The description of the request may be an easy to understand summary of the request. This is done by parsing the HTML content. The confirmation message may also contain information regarding the context in which the request is made, available through the examination of the Session-Authenticators present in the request content. The type of confirmation message to show may be specified in the associated Website/Login/Transformation records or by system-wide defaults.

In step 0530 additional input fields are shown to the user in the UI and the edition of the fields is enabled. The description of the input fields is taken from the Website/Transformation Record.

In step 0540 a decision is made regarding the need for confirmation of this request. The result is based on the description of the Website/Login/Transformation Record and global configuration. If Yes, then the user is asked for confirmation in step 0550.

In step 0550 the user is asked for confirmation using the UI user interface. The user may either confirm or deny the request, and may decide to apply the same answer for all subsequent requests for the same website, the same username, or all subsequent requests. A timeout may be used to automatically deny the request after some predefined time. If a new confirmation is required while a previous confirmation is still waiting in the UI, the new confirmation is queued and an audible alarm may be generated to notify the user of a pending confirmation. Login/Logout/Transformation records may also specify a confirmation priority for the associated request, so confirmations with higher priority may replace lower priority confirmations in the UI.

In 0560 a decision is made regarding the confirmation status of the request provided by the user. If Yes, then a confirmation acknowledge is emitted in step 0570. If No, then an error is shown in the UI and/or in the PC Browser.

In step 0570 a confirmation sound is emitted optionally, depending on the global configuration and the information on the Login/Logout/Transformation Record.

In step 0580 an error is shown in the UI and/or in the PC Browser.

In step 0590 the request is finished, and no further processing is made with this request.

In step 0610 an the Dock tries to find “Active TLS Connection Record” to the target remote website from the Connection Pool. To decide if a record on the pool is associated with the desired remote website, the remote IP is obtained from the TLS connection state. This is compared to Website IP is obtained by DNS look-up on the domain specified in the request. Only a record with “Private Outbound Keys flag” in true is selected. If an “Active TLS Connection Record” is found with the desired properties, it is selected and removed from the Connection Pool. If no “Active TLS Connection Record” is found, the Dock opens a new TLS connection to the remote website and creates an associated “Active TLS Connection” record.

In step 0615 the connection is associated with the Session Record previously selected in step 0850 or step 0305.

In step 0620 the Dock sends the part of the request that has been added the SAs to the remote website using the secure TLS connection.

In step 0630 a decision is made regarding the possibility to off-load sending the request to the PC. The Dock may require the PC to inform the HTTP Request size. If the size of the request is big, and the request is not flagged as “critical”, then the PC will handle sending the remaining data to the remote site, described by steps 0650, 0660 and 0670. If not, then the remaining part (if any) is sent by the Dock to the remote website.

In step 0650 a new SSL/TLS CipherSpec is negotiated (renegotiation) over a previous TLS session. This TLS protocol generates a new pair of inbound and outbound key sets. This can be done according to RFC5246 “The Transport Layer Security (TLS) Protocol” or RFC5746 “Transport Layer Security (TLS) Renegotiation Indication Extension” both as published by The Internet Engineering Task Force (IETF), the contents of each RFC being herein entirely included by reference.

In step 0660 the “Private Outbound Keys flag” in the Active TLS Connection record is set to false.

In step 0665 the Dock sends to the PC the outbound keys, which are required to encrypt and authenticate the outbound stream of the TLS session. Afterward, the PC will be able to use the outbound part of the TLS connection.

In step 0670 the PC uses the keys to communicate with the remote website and send the remaining part of the request. This communication is possible because the PC have the keys to encrypt and authenticate the outbound stream. The inbound stream is still controlled by the Dock.

In step 0680 the Active TLS Connection Record is destroyed, and all security sensitive information, such as SAs is wiped. The associated open TLS Connected can be reused by the PC for communication with the remote website that does not require client-authentication, or the TLS connection can be closed.

In step 0690 the Dock request the PC to send the remaining part of the HTTP request to the dock. When chucks of a certain size of data are received, they are resent to the remote website over the TLS connection, until no more data is expected from the PC.

In step 0691 a decision is made regarding the need to wait for a response from the remote website. If yes, then the process is terminated, while the Active TLS Connection Record is not returned to the Connection Pool. If no, then step 0692 is executed to return the Active TLS Connection Record to the Connection Pool.

In step 0692 the Dock tries to reuse the connection by executing the process depicted in FIG. 26.

In step 0710 If not already received by the Dock the PC sends the request body to the Dock so the Dock is able to search for the Username in the POST fields. Eventually the username can be found in the GET fields.

In step 0720 the Dock searches for the Username in the POST fields. Eventually the username can be found in the GET fields. The Login Records associated with the remote website may be read to find which is the field that contains the username for that specific website. If the username is not present or it is blank, then it's not used for matching in step 0730.

In step 0730 the exact Login Record associated with the login request is found, by indexing with the header and the username value extracted from the username field. The record is retrieved for future use.

In step 0740 the Dock attempts to log in the remote website.

In step 0810 the website password is retrieved by executing the process to do so as specified by FIG. 25. This process may decrypt one or more secrets and build the password based on those secrets using a password derivation function that may be the identity function.

In step 0840 the body or the header of the request is modified to store the username (if not specified by the original request) and the password derived in step 0810.

In step 0850 a new Active Session Record is created, and is associated with the current Login Record. The new Active Session Record has empty “SAs/LIDs” and “Locators/LIDs” fields.

In step 0910 the PC sends the Request body to the Dock so the Dock can retrieve the Locators associated with the connection whose request has asked for a logout.

In step 0920 the Dock retrieves the Locators associated with the connection whose request has asked for a logout.

In step 0930 the connection is associated with the Login record currently in use.

In step 0940 the connection is marked as a “Logout request” so when the HTML response is received from the remote website, the remaining part of the logout process (which is the destruction of temporary secrets associated) can be performed.

In step 1010 all session-authenticators associated with the Login record (that is associated with the connection) are destroyed from memory (securely erased).

In step 1020 all Locators associated with the Login record (that is associated with the connection) are destroyed from memory (securely erased).

In step 1030 the Dock checks if a predefined maximum number of Logins/Logouts have been reached, and if so a password recycle is triggered. The password recycle process consist of the generation in the Dock of a new password as a random or pseudo-random string, the request of a change of password in the remote website from the old password to the newly generated one, and the storage of the new password encrypted by the Master secret in the table of auxiliary secrets. The password recycle process is carried out by the Dock without intervention of the browser. After the password recycle process is done, an informational message may be displayed on the UI or on the PC.

In step 1110 the field “Default request” of the Action Record is extracted. This is the template used that will be modified by adding passwords in order to execute the command.

In step 1120 the request is filled. This is done by executing the “Execution script” which commands what fields of the request should be modified, and what passwords should be inserted into the request. Also the script may require other inputs from the user. These inputs may be entered on the PC or on the UI. If inputs are entered only on the UI, then the UI may skip additional confirmations in the procedure User Attention (0410). The script may set the request as “critical”, which means that sending the request cannot be delegated to the PC. If the Active Session Record associated with this action has SAs listed in the “SAs/LIDs” field, they are automatically added to the response template by the “SA insertion script” present in the Website Record associated with the action that is being executed.

In step 1130 the request is performed by the Dock (see procedure depicted in FIG. 4).

In step 1210 the field “Default request” of the logout Action Record is extracted. The request contains at least the URL, PUT and GET fields, and additional cookies. This is the template used for logout from a website.

In step 1220 an open connection to the remote website is searched in the Active TLS Connection Records list. If no such record is found, a new secure connection (a new Active TLS Connection Record) to the destination website is created and associated with the Active Session record. Both private inbound and outbound flags are set to true.

In step 1230 the session is associated with a logout request. By setting the “dispose after response” flag to true, in associated Active TLS Connection Record.

In step 1240, the HTTP request is constructed and filled with the information gathered about the Logout action and from the Login Record. The process to fill the request is specified in FIG. 13.

In step 1250, the request is performed as described in FIG. 24. The connection to perform the request must have the private outbound flag set to true.

In step 1310 the passwords are obtained by executing the sub-process described in FIG. 25, for each required password.

In step 1340, the request is filled with the derived passwords, according to the specification in the Action Record. This is done by executing the “Execution script”, which commands which password must be entered in which fields. Also the Execution script may abort the request if certain predefined criteria regarding the information contained in the request is not met. The script may set the request as “critical”, which means that sending the request cannot be delegated to the PC, even if the request size is big.

In step 1410 the “Search script” of the transformation record is executed to decide if a transformation is required.

In step 1420 a decision is made depending on the result of the previous search, If a match is found, then the “Execution script” is executed in step 1430. If no, then the sub-process terminates.

In step 1430 the execution script is executed as depicted in FIG. 13 to fill the HTTP request.

In step 1510 the Dock waits until the complete HTTP header is received from the remote website on the current connection, which means that the Active TLS Connection Record associated with this response is known to the Dock and this Active TLS Connection Record is not part of the Connection Pool.

In step 1515 Session-Authenticators (active or inactive) that may be present in the header are searched and detected. Normally, the Dock receives responses from an active TLS connection, which is associated with an Active TLS Session Record. The Active Session Record is associated with a Login Record is associated with a Website Record which contains a “SA detection script”. This script is executed in this step. The script scans the response header, body, or both, in order to detect the fields used as SAs by the remote website. The SAs may be transmitted as cookies, hidden fields, private fields embedded in links (such as <a href=“http://example.com/page?auth=auth_code”>), private fields embedded in the paths of URLs (such as <a href=“http://example.com/page/auth_code/”>), or arbitrary strings in the HTML page. SAs may appear in HTML properties, or embedded in code scripts, such as JavaScript. For example HTML Web storage can be used for session management (generally using the localStorage Object). SAs for localStorage may appear in JavaScript snippets. Nevertheless the “SA Detection Script” is not limited to any preestablished authentication system, since it can parse the HTTP/HTML response, scan for parts, extract those parts, and operate upon the extracted parts in order to detect the SA fields, according to some predefined template or algorithm. If the script requires scanning the body of the response, and the body has not yet arrived, the script may block until the required part of the body arrives. The “SA detection script” generates a list of records, each one of type SAR. Each SAR record has these fields (FSA, RSP_LOC, REQ_LOC) that will be processed the step 1517. The FSA field is a string that represents a found Session-authenticator (which may or may not have been previously recorded in the “SAs” field of the Active Session Record). The REQ_LOC field represents where the FSA should be expected to be placed in a future request, and the field RSP_LOC specified the location where the FSA is was found in the response. The RSP_LOC may specify a fine grained position (the byte offset in the response, the name of a cookie, the name of the hidden field and the field scope, such as the “form” name, the path, attribute name and offset within an attribute of a specific HTML tag in the DOM (such as “html>body>div class=“xx”>table>tr>p class=“content”>a″ attribute “href”, offset 10). The REQ_LOC specifies a gross grained indicator (such as only the identifiers Cookie/Hidden-field/URL). The “SA detection script” may look-up active SAs and/or Locators and their corresponding REQ_LOC/RSP_LOC fields (present in the Active Session Record) during execution. These look-ups can help following runs of the “SA detection script” to find the SAs fields faster.

In step 1517 the script “SA/Loc replacement script” of the Website Record associated with the currently analyzed Login Record, is executed.

“SA/Loc replacement script” accepts the list of SAR records detected in step 1515. This script may either replace the SAs by locators in-place, or remove the original SAs completely and insert one or more locators using a different kind of authentication fields, or a combination of both methods. As an example of the first method, the script takes each FSA string in each SAR record in the list and searches for it in the list of active SAs (“SAs” field) present in the Active Session Record being analyzed. For each match, the original FSA string is removed from the response and a corresponding locator (present in the “Locators” field) is inserted in the same place. If the FSA is not found, the script can automatically create a new SA equal to the FSA by recording it in the “SAs” field, and create a new locator, record the locator it in the “Locators” field so it gets associated with the FSA, and perform the removal/insertion procedure described before. The REQ_LOC field is different from the RSP_LOC field. Common REQ_LOC values are: Cookie, URL path, URL query strings (name/value pairs of GET request), name/value pairs of POST request (internet media type application/x-www-form-urlencoded) and strings in a multipart/form-data and strings in a JSON object send as application/json content-type.

As an example of the non in-place transformation, the replacement script instead transforms the response and removes complete sections that enclose the FSAs or that refer to a FSAs, and insert locators at different places. For example, the script can detect a FSA cookie being sent by the server, remove the “Set-Cookie:” header used to send the cookie, store the cookie as a SA in the “SAs” field, together with the original RSP_LOC and REQ_LOC values, create a locator that consist of a random string, and name it “Locator1”, insert the new locator in the “Locators” field with RSP_LOC set to “Form-Field”, and insert a hidden form field “<input type=“hidden” name=“Locator1” value=“random”>” in the response. The hidden field is used afterward, if received back from the PC, to trigger the opposite action. The name and/or content of locators can be random, pseudo-random, derived by a function from the original name and/or content of the SAs, or any combination of these methods.

Also in this step all global locators are searched and replaced automatically by the corresponding SAs, to permit cross-site authentication, as specified in step 0305. Global Locators should be stored with a predefined REQ_LOC, to narrow the extent to look up for them in the HTTP request. If no REQ_LOC is given, the locators are searched and replaced in all the request stream.

In step 1520 the HTTP body or HTTP header are transformed according to the predefined transformations, as described in the sub-process “Transform Body/Header” (FIG. 14).

In step 1560 the user may be notified of the response in the UI, by executing the sub-process depicted in FIG. 17.

In step 1610 a decision is made depending the state of the flag “Dispose after response” found on the Active TLS Connection Record. If the flag is true, then the “Internal logout” process of step 1615 is executed.

In step 1615 the “Internal logout” process (FIG. 10) is executed. This process ensures the all security sensitive information associated with the previously opened session is destroyed.

In step 1620 the Dock sends to the PC the part of the response that has already been received (and may have been transformed). This may have been only the header, the header plus a prefix of the body, or all the response.

In step 1635 a new SSL/TLS CipherSpec is negotiated (renegotiation) with the remote Website, in order to destroy the previous encryption and authentication keys and generate new keys both for inbound and outbound streams. This can be done according to RFC5246 or RFC5746.

In step 1639 the Dock data is received from the remote website over the TLS connection, and the same data is it is sent to the PC, until no more data is expected from the remote website.

In step 1640 the inbound keys (the keys used by the remote website to encrypt data and compute and authenticate that data) is sent by the Dock to the PC.

In step 1645 the PC uses the received keys to take control of the inbound part of the TLS connection and receive the remaining part of the Response directly from the remote website, decrypting and verifying the authenticity of received data.

In step 1650 the Dock tries to reuse the current Active TLS Connection Record by executing the process specified in FIG. 26.

In step 1710 a decision is made regarding the need to display or log a summary of the response, based on the global configuration of the UI and the confirmation options of the action that is being notified.

In step 1720, the “Response parser script” is executed. A parser script must construct a message intelligible by the user, suitable for being rendered in the UI, showing the fields of the request/response that are required to provide a proper information and logging of the event.

In step 1730, the information message generated in step 1720 is shown on the UI, if both global configuration options and per action options indicate so.

In step 1740, the information message generated in step 1720 is logged in any subset of these places: the UI, the Dock a remote server or cloud storage, depending on the global configuration options and per action options configuration options.

In step 1750, an audible sound alarm is emitted, if both global configuration options and per action options indicate so.

In step 1810 a decision if made regarding the need to ask the user to enter the PIN (Personal Identification Number) or use the PIN which was temporarily stored in volatile memory if it was previously entered. Even if the PIN is stored in memory, the UI may decide to ask for it again if a maximum time has elapsed, a physical sensor has detected suspicious activity (e.g. high accelerations measured by an accelerometer) or any other software security-related event. If the PIN is asked, step 1820 is executed. If not, step 1815 is executed. If a wrong PIN is entered multiple times, the UI may lock the device to prevent a brute force PIN scanning attack. If can also delay the PIN checking to make brute force scanning too costly in time.

In step 1820 the UI asks the user for the PIN, using its own user interface.

In step 1830 the PIN is verified. If it's incorrect the PIN is re-asked up to 3 tries. If still the PIN is incorrect, the process fails.

In step 1840 the Master Secret and an associated MAC authentication tag are retrieved from tamper-proof memory.

In step 1845 the encrypted Master Secret integrity is verified by computing a MAC using a fixed key.

In step 2010 a command list based on action records is build. The list contains all action records that are marked to be listed in a menu. When a Login action is referenced by more than one Login Record, the action is presented multiple times, specifying the available usernames for login. Each visual item identifies an action, and a username.

In step 2015 a visual representation of the list of actions is created. The representation of choice is HTML, and this is presented in the PC Browser for the user to navigate. The user navigates this HTML webpage and clicks on an item, which selects it.

In step 2025 the action associated with the selected item selected item is identified.

In step 2030 a decision is made regarding the type of action selected. If the action is a Login, step 2035 is executed. If not, step 2040 is executed.

In step 2035 the Login action is executed.

In step 2040, a decision is made regarding the need to login before executing the action. This condition depends on arguments specified by the Action Record and the existence of an Active Session Record for the same username. If the action requires login, and there is no active Session Record for that username, then Auto Login is required, and step 2045 is executed. If not, step 2050 is executed.

In step 2045 an automatic Login action is executed. Auto Logins are similar to manual logins, but the request template is taken from the “Default request” field, instead of being provided by the PC. Username and password fields are filled in a similar way as the Manual Login procedure. This is done by the process “Execute Action” depicted in FIG. 11, for the Login Action Record.

In step 2050 the selected action is executed. The action is executed by using the “Default request” field as template, and sending it to the remote website. This is done by the process “Execute Action” depicted in FIG. 11, for the Login Action Record.

In step 2055, the sub-process Collaborative Send Request to Internet (depicted in FIG. 6) is executed.

In step 2060 the response to the request is processed in the Dock, by executing the sub-process

“Process Response in Dock” depicted in FIG. 15.

Data 2115 is a Connection Pool, which is a list of Active TLS Connection Records that are available to be Data used for subsequent TLS requests.

Data 2120 is an Active Session Record. The Dock stores Active Session Records for each combination of user/website that has signed in, and not yet signed out.

Data 2114 is a list of Session-authentications (SAs). Each SA item also has a REQ_LOC and RSP_LOC fields.

Data 2115 is a list of Locators. Each locator item also has a REQ_LOC field.

Data 2116 is a pointer to (unique identifier of) a Login Record, with specified the user credentials (username) of this open session.

Data 2120 is an Active TLS Connection Record, which encapsulates the state of a TLS connection, along with other state information required for pool connection management and inbound/outbound streams delegation optimizations.

Data 2122 is a flag that indicates if the keys (encryption and MAC) required to send information over the TLS connection to the remote website have been sent to the PC.

Data 2124 is a flag that indicates if the keys (encryption and MAC) required to receive information over the TLS connection from the remote website have been sent to the PC.

Data 2126 is the state of the TLS connection, which is an opaque handle or data provided by the TLS layer to identify an open TLS connection.

Data 2128 is a pointer to an Active Session Record that is associated with this connection. Associations between connections and session records are temporary, an last as long as a request or response is being processed. When the Connection Record is returned to the Connection Pool, the association is removed.

Data 2130 is a flag that, if true, indicates that a request has been performed over this TLS connection to logout form the remote website. This flag is used to allow the wiping of all security sensitive information related with the session and free unused memory space, after a positive logout response has been received.

Data 2140 is a Website record, which specified all the actions a remote website supports.

Data 2142 is the Website URL.

Data 2144 is the URL of an external website that handles authentication, when authentication is delegated to a fixed third party. If not delegation is used, this field is left empty. This field is used by the Dock to automatically establish cross-site sharing of authentication tokens.

Data 2146 is the Login Action associated with this website.

Data 2148 is the Logout Action associated with this website.

Data 2150 is the Change Password Action associated with this website. If configured to do, the dock may periodically recycle remote website passwords, transparently and without user intervention, using this predefined action. Also the user may trigger an automatic recycle of a subset of passwords if he thinks they have been compromised.

Data 2152 is the Change e-mail Action associated with this website. If the user changes his primary e-mail address, he may request the Dock to automatically log in all remote websites where the old e-mail address was registered and update them with the new e-mail address.

Data 2154 is the Delete Account Action associated with this website. The user may command the Dock to automatically delete the account of a subset of the websites the user has previously registered with.

Data 2160 are other user-provided actions associated with this website.

Data 2161 is the “SA detection script”. This script is used to detect SAs for this website in the remote site responses. If this script is empty, SAs are automatically detected as hidden fields and cookies with the “secure” attribute.

Data 2162 is the “SA/Loc replacement script”. This script is used to replace found SAs with locators, in a way compatible with the associated website. If this script is empty, a standard one-to-one mapping of SAs to pseudo-randomly chosen locators, preserving the authentication method, is used.

Data 2163 is the “Loc/SA replacement script”. This script is used to replace locators with SAs, in a way compatible with the associated website. If this script is empty, a standard one-to-one mapping of the locators to the stored SAs is used.

Data 2164 is the “SA insertion script”. This script is used to insert SAs into empty request templates when an action is triggered by the Menu provided by the Dock. If this script is empty, all SAs stored in the Action Session Record are inserted into the request. Each SA is inserted in the location specified by the associated field RSP_LOC.

Data 2170 is the Transformation Record. This record specifies a free transformation of a request or a response. Transformations are scanned and applied even if no Active Session Record is present (no previous login).

Data 2171 is the Website where this transformation will be enabled. If empty, the transformation applies to any website.

Data 2172 is the search pattern (regex) or a search script that must be executed to find the strings that will be replaced.

Data 2174 is the replace pattern or replace script that must be executed to insert the required strings. The strings to insert may contain passwords or any data derived from secrets stored in the UI.

Data 2176 is the confirmation and logging options, if user confirmation and/or logging should take place when the search script or pattern search detects a positive match.

Data 2180 is The Login Record. This record specifies user credentials and method of authentication for a certain username and a remote website.

Data 2181 is the Website associated with this Login Record.

Data 2182 is the username to be used for login in the remote website.

Data 2184 is the External Login Record, which points to another Login Record, which indicates that this login is performed on a delegated third party website. For example, if the user is using OpenID, this field contains a pointer to a Login Record specifying the OpenID login credentials for an OpenID provider. The Dock uses this information to establish enabled cross-site SA exchanges between both remote websites. IF this field is empty, it means that the same website handles its own authentication.

Data 2186 is a pointer to an Action Record that specifies how to detect and build a Login request to the remote website.

Data 2187 is additional personal data (such as e-mail, full name, address and telephone) that can be used by scripts to send in requests or detect in responses.

Data 2191 an Action Record. The Dock may store many action records. Each Action Record specifies how to carry a request and how to detect if the PC is issuing that request.

Data 2192 is the Detection pattern/script. This field specifies either a regex pattern or a script that must be executed to detect if a certain HTTTP request is considered to perform that action.

Data 2193 is the Execution script. This script can perform any modifications to the request required to perform the action. Also the script can automatically block the action if a predefined criteria is not met. For example, Login Actions generally insert the username in a preestablished name/value associated with a username form input field. Other actions may insert other specific information. For example, an e-mail sending action may insert at the bottom of the e-mail text a note regarding the confidentiality of the message and at the same time block any outgoing message that does not have an expected digital signature.

Data 2194 is the Confirmation/Log options field. This field indicates whether this action should rise confirmations and whether this action should be logged locally in the Dock, in the UI, in a remote server of in the cloud.

Data 2195 is the Default Request. This is a template of a request for this action that is used when the action is triggered by the Menu (instead of being triggered by the PC browser sending the request).

Data 2197 is the Request parser script. This script parses the request and builds a user confirmation and logging message suitable to be presented to the user before the request is sent.

Data 2198 is the Response parse script. This script parses the response to the request and builds a user confirmation and logging message suitable to be presented to the user after the response to the request has been received.

Step 2410 the Dock searches for an active TLS connection to the remote website, by iterating thought the Active TLS Connection Records stored in the Connection Pool. Within each record, the field TLS connection state specifies the IP of the remote endpoint, and this is compared to the IP obtained by DNS lookup of the website domain.

Data 2210 is the UI-Active Session Record, which is stored in the UI. This is a record similar to the Active TLS Session Record stored in the Dock, but only stores the SAs. It is used to detect open sessions that were not properly signed off. For each Active TLS Session Record in the Dock there is a UI-Active Session Record in the UI.

Data 2212 is the list of SAs used by active session.

Data 2215 is the UI-Website Record, which is stores in the UI. This is a record similar to the Website Record in the Dock, but stores less fields.

Data 2217 is the Website URL.

Data 2219 is the Last Website IP, used to detect DNS poisoning attacks.

Data 2240 is the UI-Action Record. For each Action Record in the Dock there is an UI-Action

Record in the UI.

Data 2241 is the confirmation/Log options. This is a copy of the confirmation/Log options present in the Dock, mirrored in the UI to prevent a Dock which has been tampered to try to bypass confirmations. The UI will always inform and/or confirm the action name, remote website and username when the associated passwords are being requested by the Dock if confirmation options of the UI are configured to do so.

Data 2244 is the list of pointers to UI-Password records, from which the required passwords can be derived.

Data 2230 is the UI-Transformation Record. This record is similar to the Transformation Record present in the Dock.

Data 2236 are the Confirmation/Log options.

Data 2238 is the search string hashing policy. An action in the dock request to scan a response to detect if a password is being sent back from the server to the PC, and remove/replace the password in the response, or block the response completely. In this case the UI may be configured to send the Dock the passwords hashed, instead of in plaintext. The script therefore hashes every candidate string in the response trying to find a match with one of the hashed passwords. This prevents passwords being transmitted to the Dock without being actually required to perform a request. The search string hashing policy establishes the hashing methods for the passwords sent (including the possibility of no hashing at all begin performed).

Data 2239 is a list of pointers to UI-Password records, from which the required passwords can be derived.

Data 2180 is the UI-Login Record, similar to the Login Record stored in the Dock.

Data 2181 is the website field, similar to the one present in the Login Record stored in the Dock.

Data 2182 is the username field, similar to the one present in the Login Record stored in the Dock.

Data 2184 is the External Login record field, similar to the one present in the Login Record stored in the Dock.

Data 2186 is the Confirmation/Log option field, similar to the one present in the Login Record stored in the Dock.

Data 2188 is the list of pointers to UI-Password records, from which the required passwords can be derived.

Data 2150 is the UI-Password Record. Each password requires by an action, being fixed or one-time, has a corresponding UI-Password record in the UI.

Data 2154 is the password derivation function. This function establishes how to build the password based on the secrets, the current date/time and the OTP counter. This field is used for one-time-passwords (either Time-synchronized, such as TOTP or math-based, such as challenge response, or hash chains)

Data 2158 is a list of pointers to UI-Secret records. UI-Secrets are the core unit of secure information that must be stored in tamper-proof memory. A password may be built using one or more secrets.

Data 2190 is the UI-Secret Record. Each UI-Secret Record stores a secret binary string in a tamper-proof memory.

Data 2191 is the encrypted secret stored in tamper-proof memory. The decryption key is the Master Secret.

Data 2192 is the MAC of secret, an authentication tag to detect if the secret is valid or not.

Data 2193 is the sync root secret field. This field can point to a parent secret, and establish a relation between secrets. The relation is that when the root secret is recycled, the child secrets should also be recycled.

Data 2194 is the creation date of the secret. This is used to detect secrets that have not been recycled for a long time, which may indicate a higher risk that passwords based on this secrets may have been compromised.

Data 2195 is the expiration date. After this date the secret should no longer be used.

Data 2196 is the use count, which counts how many times the secret has been requested by the Dock, through a password request.

Data 2197 is the key exposed flag. This flag can be set by the user to indicate this secret has been exposed, and so the passwords of remote websites associated with this secret should be recycled.

Data 2198 is the Bit strength of the secret, which estimates the entropy of the secret.

Data 2130 is the UI-Master Secret Record.

Data 2132 is the master secret encrypted with the PIN and salt, using a key-stretching method.

Data 2134 is the Master secret authentication tag, which is a MAC digest over the encrypted master secret.

Data 2138 is the “salt” binary string used in conjunction with the PIN, to derive the master secret encryption key and MAC authentication key, using a key-stretching method and a Key-derivation-function.

Data 2150 is the UI-Pin Record

Data 2152 is the secret PIN in use.

In step 2510 the Master secret is obtained from UI storage, after a PIN has been entered successfully, as specified in FIG. 18.

In step 2520 the password record is read and all auxiliary secrets associated with this Password Record are decrypted from the secret records using the Master secret as key.

In step 2530 a website password is derived from Master Secret, auxiliary secrets, URL, username, OTC Password Counter, and RTC. The derivation function can make use of any subset of these variables and any computable function. This can be a simple function that just picks an auxiliary secret as the password. Other derivation functions may include Timed or Counter One-time-passwords (OTPs).

In step 2540 auxiliary secrets may be updated according to a pre-defined function (such as a Cryptographically Hash function) and also password counters may be incremented. This is required for some OTPs schemes.

In step 2650 the association between the current Active TLS Connection Record and the current Session Record is broken.

In step 2660 if all the keys related with TLS connection have been sent to the PC, step 2670 is executed. If at least one set of keys (inbound or outbound) have not been sent to the PC, step 2665 is executed.

In step 2670 the Active TLS Connection Record is destroyed, and all security sensitive information, such as SAs is wiped. The associated open TLS Connected can be reused by the PC for communication with the remote website that does not require client-authentication, or the TLS connection can be closed.

Regarding FIG. 38 and FIG. 39:

M103 is a Browser, which is a software that renders information received from the Internet in a display suitable for the comprehension of the information by users. The browser is adapted or configured to communicate with the M/R module, channeling some outbound and inbound connections through this module.

M104 is the Multiplexer Router (M/R) Module. This module provides the service of multiplexing and routing connections between the PC, the dock and a server, the server typically being in the Internet and serving a website by means of HTTP/HTTPS/TCP/TLS/WS/WSS (Secure WebSockets)/FTP/FTPS (FTP over TLS) protocols. Connection routing decisions are based on user-configuration, scripts provided by the dock, and direct commands sent by the dock.

M102 is the PC environment, which executes the Browser and M/R module software.

M101 represents the modules running in trusted environment. The portion corresponding to the Dock can:
a) Build HTTP requests for remote logins
b) Command the UI to ask the user to confirm the request.
c) Retrieve passwords from protected memory in the UI or in encrypted cloud storage. This remote storage is considered part of the trusted environment since encryption prevents others to access the plaintext of the passwords.
d) Insert usernames and passwords in Requests.
e) Connect to remote sites over a TLS connection using the PC as an Internet gateway.
f) Send Requests over secure connections
g) Accept responses over secure connections
h) Detect the presence of Session-Authenticators in responses and replace them by Locators
i) Detect locators in new Requests coming from the browser and replace them by Session-authenticators.

And the portion corresponding to the UI can:
a) Ask the user for a PIN and verify the correctness of the PIN.
b) Ask the user for confirmation of actions requested by the Dock, by means of its user-interface.
c) Ask the user for confirmation of passwords requested by the Dock, by means of its user-interface.
d) Store secrets in non-volatile tamper-proof memory.
e) Build passwords from these secrets, using an derivation function that may access a Real Time Clock (RTC).
f) Send these passwords to the Dock.

M106 is the website server module, which provides functionality for HTTPS protocol communication, and is capable of hosting of a webpage for handling an authentication operation being performed with a login operation. Also the website server module allows retrieving records for checking the validity of a username and a password.

M103 is a browser module capable of browsing based on the obtained authentication data representative of an established login session;

M104 is a routing software module, capable of providing the service of multiplexing and routing connections between the first computing environment, the browser and the website server. The routing software may handle a set of Internet protocols, such as (but not limited to) HTTP, HTTPS, TCP, TLS, WS, WSS (Secure WebSockets), FTP and FTPS (FTP over TLS). Connection routing decisions are based on user-configuration, scripts provided by the first computing environment, and direct commands sent to the routing software module from the first computing environment.

M105 is a software module that provides the USB Flash Drive functionality. This functionality allows the first computing environment to present an emulated USB flash drive to the second computing environment. This emulated USB flash drive may provide additional functionality such as:
a) Restricting read, write or read/write accesses to certain files or folders or the whole volume, including any mixture of files, folders and volume with different read/write permissions, based on a configuration or by requesting user confirmation using the user interface or by detection of the identity of the second computing environment and using a preconfigured list of whitelisted environments.
b) Passing control messages back and forth the first computing environment and the second computing environment using a virtual file.
c) Sending data streams from the first computing environment to the second computing environment and vice-versa using a virtual file.
d) Storing a verified and secure version of the browser in case that the second computing environment does not provide a suitable web browsing software. The browser may be stored ready to be executed or in packaged form for installation.
e) Storing the routing software module for being installed or directly executed by the second computing environment.
f) Storing a secure bootable operating system containing a web browser and route multiplexing software module.
g) Storing a virtual image of an route multiplexing software module containing a web browser and operating system and the corresponding virtualization software.

M107 is a software module that provides SSL/TLS functionality such as the OpenSSL. NSS, MatrixSSL, PolarSSL, wolfSSL, SharkSSL, CyaSSL libraries.

M110 is a software module that, provides services to detect input events and emit outputs from an input and output device respectively. Depending on the specific input user interface device used detected inputs events may be button presses, key presses, accelerations, changes in position, pressure, sounds, light changes, capacitive proximity, wireless signal proximity, temperature variations, writing with a pen, reading fingerprints, scanning the retina or analyzing any other biometric authentication data. Outputs may be displaying text, displaying icons, emitting sounds, emitting recorded voice messages, synthesizing voice messages, turning on or turning off LEDs, flashing LEDs, changing LED colors and vibrating.

M109 is a software module that provides some or all of the following functions:
a) parsing HTTP requests.
b) Parsing HTTP responses.
c) Extracting header fields and content from HTTP messages.
d) Creating new HTTP requests
e) Creating new HTTP responses.
f) Modifying HTTP messages by adding, deleting, modifying or inserting data, such as header fields or body.

M108 is a software module that allows obtaining the password from a non-volatile memory, generating a new password using a physical random number generator or a pseudo-random generator, deriving the password from data consisting essentially of a main secret and an UR, deriving the password from data consisting essentially of said main secret, an URL and the username, decrypting the password using a PIN entered in said user interface. deriving the password from data comprising a main secret being stored in said non-volatile memory, searching the password by matching with the username, using a password database, changing a password, managing a plurality of different passwords for each website server, computing One-Time-Passwords. Regarding password administration, new passwords may be loaded into the trusted environment from a different trusted computer to prevent them being spoofed while they are being transferred. The Dock should authenticate the user by any of several ways such as requiring a password, requiring performing a challenge response protocol, and/or establishing a SSL/TLS connection authenticated by client and server certificates. Also new passwords may be transmitted to the trusted environment using the UI user interface, by means of, for example, a small keyboard or buttons. Another way of entering the passwords, is by booting an entire operating system stored in a flash accessible the Dock (so even a standard PC can be trusted), and running after the boot an application specially adapted for communicating with the dock, for storing the password. Then the Dock can check the validity of the loaded passwords and suggest an immediate change using a newly and automatically generated password. Another convenient option is using the password recover option of the website (such as receiving a confirmation to a user-specified e-mail), and the Dock automatically receiving the e-mail to continue the password change procedure. Mail receiving can be done by using in the Dock the user authentication data required to access the e-mail, in the case of a web-mail the login to the webmail can be done the same way described for other websites. The password database can be sent in encrypted form to another system such as a cloud server.

Regarding FIG. 40 to FIG. 53:

Alternative processing steps of an alternative embodiment are also considered, as follows:

In step 0110 the Network is configured so the UI can communicate with the Dock through a secure channel (encrypted and authenticated).

In step 0120 the PC is configured to run the Stream Multiplexing System.

In step 0130 The PC Browser application is read (preferably from a secure source such as an read-only pen-drive, the Dock or the a secure site on the Internet). Afterward the PC Browser application is launched.

In step 0140 a decision is made regarding the visualization or not of the Command/Login Menu. The decision is based on the Configuration stored in the Dock and may also be based on the identification of the PC running the PC Browser.

In step 0150 the Menu is build and shown to the user as a HTML rendered page in a tab of the PC Browser.

In step 0160 the PC Browser starts normally and begin to process user interactions and construct HTTP/HTTPS request.

In step 0210 The PC browser loops waiting for user Interaction or automatic triggering of HTTP/HTTPS requests.

In step 0220 the PC Browser creates a new request HTTP/HTTPS request.

In step 0230 a decision is made regarding the forwarding of the request to the Dock or to the Internet. If the request contains well-formed Locators then the request is redirected to the Dock. If the request is HTTPS and matches preconfigured URL patterns, it is also redirected to the Dock. Otherwise the request is handled normally.

In step 0240 the header of the request is sent to the Dock in. The Dock is able to read the request header and recover the plaintext.

In step 0250 the Dock process the request in order to analyze if it is associated or will be associated with a secure operation.

In step 0260 the request is sent to the Internet without going through the multiplexing system.

In step 0270 the response is received normally from the Internet without going through the multiplexing system.

In step 0305B the request header is analyzed by the Dock searching for well-formed Locators. Locators are stored in HttpOnly cookies, present in the request header. To detect Locators, the Locator name is searched in a table of active locators is searched stored in the Dock.

In step 0310B a decision is made regarding the existence of well-formed, active Locators in the header. If Locators are found, then the header must be added associated authentication. Otherwise the header is left as is.

In step 0315B Session-Authenticators associated with the found Locators are inserted in the header, and the said Locators are removed.

In step 030B the header is analyzed searching for total or partial matching records of type Login or Transformation in a table stored in the Dock.

In step 0325B a decision is made regarding the existence of at least one matching Login Record for the Login operation. If the Login record is found, then special processing is done in 0330B to such requests. If not, then other condition is checked in 0335B.

In step 0330B the procedure of Manual Login Attempt is executed. This procedure inserts in the request a password derived from auxiliary encrypted secrets.

In step 0335B a decision is made regarding the existing of at least one matching Login Record for the logout operation. If the Login record is found, then special processing is done in 0340B to such requests. If not, then other condition is checked in 0345B.

In step 0340B the procedure of Manual Logout Attempt is executed. This procedure ensures that the request is sent to the remote website in a secure way, checks for a positive response and destroy all Locators/Session-Authenticators associated with the Login Record.

In step 0345B a decision is made regarding the need to transform the header or the body of the request. Transformations of the header/body includes, but is not limited to, the insertion of credit card numbers, higher level password, specific request passwords, as GET/POST fields.

In step 0350B a decision is made regarding the need to transmit a portion of the body from the PC to the Dock in order to read it or modify it. If Yes, then the body/header will be transformed in 0360B. If No, then no transformation takes place.

In step 0355B a decision is made on if the header was modified or not by the process that sets the authentication in header (step 0315). If yes, then the request is performed by the Dock. If No, then then the request can be handled by the PC.

In step 0370B the multiplexing system is informed by the Dock to redirect the request (both input and output) to the Internet. The PC completes the request directly to the Internet, through the multiplexing system.

In step 0375B the PC retrieves the response from the Internet, through the multiplexing system.

In step 0360B the header and/or body of the request is transformed according to the rules present in the matching Transformation Record.

In step 0365B the Dock continues processing the request and decides what parts of the request and response will be handled by the Dock and what parts will be handled by the PC.

In step 0410 the user is send confirmation messages describing the current request and the flow is allowed to be paused until the user confirms or rejects the transmission of the request to the Internet.

In step 0420 the request is sent to the Internet by the PC or by the Dock, depending on security and performance considerations.

In step 0430 a response portion is received by the Dock and the Dock decides if the Dock will receive the remaining portions, and then the request will be handled to the PC or the PC will receive them directly from the Internet.

In step 0510 a decision is made regarding the need to alert the user of a request that requires more security. If Yes, then a message will be displayed to the user in 0520. If No then nothing happens.

In step 0520 a message is shown to the user in the UI.

In step 0530 additional input fields are shown to the user in the UI and the edition of the fields is enabled. The description of the input fields is taken from the Transformation Record.

In step 0540 a decision is made regarding the need for confirmation of this request. The result is based on the description of the Transformation Record and global configuration. If Yes, then the user is asked for confirmation in 0550.

In 0550 the user is asked for confirmation using the UI user interface. The user can either confirm or reject the request.

In 0560 a decision is made regarding the confirmation status of the request provided by the user. If Yes, then a confirmation acknowledge is emitted in 0570. If No, then an error is shown in the UI and/or in the PC Browser.

In step 0570 a confirmation sound is emitted optionally, depending on the global configuration and the information on the Transformation Record.

In step 0580 an error is shown in the UI and/or in the PC Browser.

In step 0590 the request is finished, and no further processing is made with this request.

In step 0710B the PC sends the request body to the Dock so the Dock is able to search for the Username in the POST fields. Eventually the username can be found in the GET fields.

In step 0720B the Dock searches for the Username in the POST fields. Eventually the username can be found in the GET fields. If the username is not present or blank, then it's not used for matching in 0730B.

In step 0730B indexing with the header and the username and exact Login Record is found. The record is retrieved for future use.

In step 0740B the Dock attempt to log in the remote website.

In step 0810B the Main secret is obtained by decryption with the pin.

In step 0820B all auxiliary secrets associated with this Login record are decrypted from a memory using the Main secret as key.

In step 0830B a password is derived from Main Secret, auxiliary secrets, URL, username, Password Counter, and RTC. The derivation function can make use of any subset of these variables. A simple function such as the password is an auxiliary secret is considered a derivation function. Other derivation functions may include Timed or Counter One-time-passwords (OTPs).

In step 0840B auxiliary secrets may be updated according to a pre-defined function (such as a Cryptographically Hash function) and also password counters may be incremented. This is required for some OTPs schemes.

In step 0850B the body or the header of the request is modified to store the username (if not specified by the original request) and the password derived in 0830B.

In step 0910B the PC sends the Request body to the Dock so the Dock can retrieve the Locators associated with the connection whose request has asked for a logout.

In step 0920B the Dock retrieve the Locators associated with the connection whose request has asked for a logout.

In step 0930B the connection is associated with the Login record currently in use.

In step 0940B the connection is marked as a Logout request so when the response is received the remaining part of the logout (the destruction of temporary secrets associated) can be performed.

In step 1010 all session-authenticators associated with the Login record (that is associated with the connection) are destroyed from memory (securely erased).

In step 1020 all Locators associated with the Login record (that is associated with the connection) are destroyed from memory (securely erased).

In step 1030 the Dock checks if a predefined maximum number of Logins/Logouts have been reached, and if so a password recycle is triggered. The password recycle process consist of the generation of a new password using a random or pseudo-random string, the request of a change of password in the remote website from the old password to the newly generated one, and the storage of the new password encrypted by the Main secret in the table of auxiliary secrets.

In step 1110B information required to be inserted in the command request is read from the Command Record

In step 1120B the request is filled with the Command Record information and possible other inputs from the user.

In step 1130B the request is performed by the Dock.

Further Alternative embodiments follows.

In an embodiment it's considered the authentication of important transactions such as: confirming a purchase or spending and the input of the credit card, as examples of possible operations.

A possible embodiment is considered based on a delegator, that does part of the communication without revealing the secret authentication information to a second device which does the other communication part. If the delegator has an input interface (but not output): An usual problem with prior systems is considered that at the moment of confirming, you don't know to whom you're communicating, nor what is being communicated, nor how much of a determinate parameter, nothing. If in that prior systems there's no input not output interface, then another usual problem is considered regarding possibly unlimited transactions being allowed by a malware request. If there's an output interface on that prior systems (but no input interface), it can be known to whom it connects but it's considered the usual issue in that prior systems of not being possible to confirm the operation. Another problem of such prior systems is considered that if the user does much many habitual transactions it can be annoying confirming them continuously using that prior systems. A considered embodiment permits whitelisting the transactions/connections enabled by, for example: arbitrary conditions over the connection, from the computer or from the device the first time that the transaction is done.

The present invention considers solutions to the above problems.

FIG. 27 shows a hardware architecture for an implementation of the “Dock” module. There's a microprocessor 1 with internal RAM 3 and internal Flash memory 20, an USB interface 24 capable of connecting to a PC, an internal cryptoengine 25 capable of accelerating encryption and decryption for common TLS symmetric cyphers, and SD memory interface 26 for using the dock as a Mass Storage Device capable of encrypting content, an UART 27 for connecting the microprocessor 1 to a BLE Blue-Tooth interface 15 capable of connecting to a Blue-Tooth enabled PC, and a serial interface 28 capable of being connected through a 4-pin connector 29 to the UI module.

FIG. 28 shows a hardware architecture for an implementation of the “UI” module. There's a microprocessor 7 with internal RAM 30 and internal Flash memory 31, a real time clock 32 useful for secure time-stamping, a BLE Blue-Tooth interface 8 capable of wirelessly connecting to the Dock (accessible through an UART 33 by the microprocessor 7), an internal crypto engine 34 capable of adding an extra layer of security to the Blue-Tooth wireless channel, a speaker 10 capable of calling the user attention, a serial interface 36 capable of connecting the UI module with the Dock by using wires and a 4-pin connector 3, and a battery with charger 35 capable of supplying power and taking power from the 4-pin connector 37 for charging the battery. The microprocessor 7 also has exclusive control of a display 9 and of input devices such as buttons 11.

FIG. 29 shows a hardware architecture for an implementation for the “Standard Platform” module. There's a motherboard 40 having a CPU, RAM and persistent storage, and associated there's a USB interface 39 capable of wired connection to the Dock module, a BLE BlueTooth interface 41 capable of wirelessly connecting to the UI module, a network interface 19 capable of connecting to the Internet, an LCD monitor 43 capable of displaying the pages rendered by a web browser, and a set of input devices 42 such as keyboard and mouse capable of controlling the browser.

FIG. 30 shows a hardware architecture for an implementation of a combined “Dock” and “UI” module, so it's possible that in a single portable device both functions can be present. There's a microprocessor 1 with internal RAM 3 and internal Flash memory 20, an SD memory interface 26 for using the module as a Mass Storage Device capable of decrypting stored content, a real time clock 32 useful for secure time-stamping, a BLE Blue-Tooth interface 15 capable of wirelessly connecting to the PC (accessible through an UART 27 by the microprocessor 1), an internal cryptoengine 25 capable of accelerating encryption and decryption for common TLS symmetric cyphers, a USB interface 24 capable of communicating with the PC and a battery with charger 35 capable of supplying power to the internal devices and taking power from USB interface 24 for charging the battery, and a speaker 10 capable of calling the user attention. The microprocessor 1 also has exclusive control of a display 9 and of input devices such as buttons 11.

FIG. 31 shows a hardware architecture for an implementation of an integrated “Mobile Secure Platform”, so it's possible to have a single portable device capable of an extra level of security and simultaneously powerful enough to achieve common tasks normally available on standard mobile devices such as smartphones, an example of that is graphical Internet browsing. There's a microprocessor 1 with internal RAM 3 and internal Flash memory 20, an SD memory interface 26 for using the module as a Mass Storage Device capable of decrypting stored content, a real time clock 32 useful for secure times-tamping and controlled by microprocessor 1, a cryptoengine 25 controlled exclusively by microprocessor 1 and capable of accelerating encryption and decryption for common TLS symmetric cyphers, a battery with charger 35 capable of supplying power, a speaker 10 capable of calling the user attention. There's also an UI multiplexer 44 with two data buses each capable communicating display data and input device data, where the first data bus is connected to microprocessor 1 for communicating data considered “trusted”, and the second data bus is connected to a motherboard 40 for communicating data considered “untrusted”. The UI multiplexer 44 has also a control bus 46 which is wired to microprocessor 1 for being exclusively controlled by microprocessor 1, the control bus 46 is capable of selecting if the microprocessor 1 or if the motherboard 40 are controlling the data of the user interface elements such as LCD display 9 and input devices 5. The UI multiplexer also has a control indicator 45 such as LED which informs the user how the multiplexer is configured, for example if the data displayed by LCD display 9 is coming from microprocessor 1 the LED can be lit for showing a symbol such as a “trusted” icon, so in that way the user can know if that's seeing and operating is trusted or not. The motherboard 40 has also a network interface capable of connecting to the Internet a browser that runs in a CPU of the motherboard 40. The microprocessor 1 is connected to motherboard 40 by means of a local bus 49 such as a PCI bus, that way the software running in the motherboard 40 can ask secure services of trusted software running on microprocessor 1.

FIG. 32 shows a hardware architecture for an alternative implementation of the Dock module in the form of a server. The dock as a server can be installed at the user's home so there's no need of transporting the set of passwords that can be securely stored in that dock server. There's a microprocessor 1 with internal RAM 3 and internal Flash memory 20, a cryptoengine 25 capable of accelerating encryption and decryption for common TLS symmetric cyphers, a battery with charger 35 capable of supplying power in case of power outage and being charged from a mains power supply 51, and means for connecting to the Internet such as a Digital Cellular interface (for example compatible with 4G networks) or through a WAN modem accessible from a LAN interface 52 such as a Wi-Fi adapter or an Ethernet interface. The interfaces for connecting the microprocessor 1 to the Internet are for further reaching the UI module that the user carries, for example the UI module can connect to a PC where a program accepts a request to reach the server by using for example the DNS address of the server to be connected to the UI module.

FIG. 33 shows a hardware architecture for an alternative implementation using a tamper-resistant module accessible through the standard platform. There's a secure (tamper-resistant) microcontroller 60 having a microprocessor 56 which connects to secure flash 58 and secure RAM 57 and to a cryptoengine 59 that allows doing crypto operations without revealing the secrets that can be stored in RAM and FLASH. The secure microcontroller has access to a short-range wireless interface 55 such as NFC or RFID, so the secure microcontroller can communicate with a standard platform 16 which haves its own wireless interface 54. The standard platform 16 has a motherboard 40 (typically having a microprocessor system), connectivity to Internet by a WAN interface 19 and a Blue-Tooth interface 41 that can connect to the combination of dock and UI (such as the one depicted in FIG. 30)

FIG. 34 shows a hardware architecture for an alternative implementation using an HDMI monitor for output and a HDMI switch. The device, in form of a trusted module 13 sits between a PC 16 and external keyboard/mouse 5 and monitor 10708 combination, so the device can have total control of the input and output user interface devices. The module has USB host port and connectors for the keyboard and mouse, and a HDMI output interface 4 with respective connector. For connecting with the PC the module has an USB device port on a USB bus 49 and HDMI input with corresponding bus 48. The PC has USB a host connector, HDMI output and WAN interface which can connect to Internet. In the module there's a microprocessor 1 with RAM 3 and flash 20, access to the USB host ports, real time clock 32, a cryptoengine 25. The microprocessor also can send video data over an HDMI bus 47 and can control an HDMI switch 44 10710 over a control bus 46. The HDMI switch can select the source of the video data between the microprocessor 1 or the PC 16, indicating the selected source with LEDs 45. That way when a program running in the trusted module generates and outputs an image, it can show with the LEDs the source so the user can trust the information displayed, for example when requiring confirmation of an operation such as a payment. A way of deciding if showing the images from the trusted module or from the PC, can be depending of the pressing of a key. For example, the program running in the trusted module can monitor the state of a “master” button 50 with mechanical auto-release function, and if and only while it's hold down, the image from the trusted module is displayed and confirmation with the mouse is monitored. That way the user can have more confidence regarding the operation is being correctly confirmed, for example since it's more difficult that the PC generates a similar confirmation image while the user forgets to check the indication LEDs. Also, if there's only a led, once it indicates the trusted source, a confirmation would be required blocking other device functionality, to avoid getting out of the trusted state without answering. It's considered that instead of a PC and an HDMI monitor, the entire system can be implemented within a mobile phone, where the HDMI bus can be replaced by the bus of an integrated display and the input devices by the integrated keyboard or touchscreen. Since it was shown how to keep security besides forgetting to check the status LEDs, they can be missing relying only on the master button. Another advantage of the master button is that it allows non-blocking confirmation, for example while confirmation is needed, a user can answer an incoming call that can control the display, and then return to the confirmation screen after the call ends. The untrusted software optionally can know there's confirmation required just to remind the user to press the button, but if malware on the untrusted side makes the device work different, it's not that problematic since what's lost is just the on-screen reminder (the user always can check what needs confirmation, if any, at any time by pressing the button, and the need of confirmation can be informed by another indicator for example by a light inside the button). Further, there can be multiple confirmations pending and by the press of the button (or by any other way to see the trusted environment screen), the user can confirm or cancel multiple confirmations windows sharing the display.

Other embodiments and their advantages are listed as follows.

The present invention provides some advantages when interacting with a website server using the HTTPS protocol capable of an authentication operation being performed with a login operation using records on the website server for checking a username and a password, by executing the following operations: Arranging a first (trusted) computing environment by securely coupling a first data processor, an user interface, a RAM memory (that can be volatile and temporary) and a non-volatile memory permits the advantageous existence of a security barrier with respect to a second (untrusted) computing environment besides being in communication with the first computing environment, and the second computing environment can be advantageously more resourceful for running a browser. The possibility of deciding whether to perform the login operation in the first computing environment advantageously allows for a secure decision, since it's infeasible for a malware running in the first computing environment to take the decision without user consent. The possibility of obtaining the password from said non-volatile memory allows to recall the password any number of times from a controlled storage, being that advantageous since if the password were obtained from a memory not being part of the first environment, malware could obtain the plain text using several attacks. By inserting the password into an HTTP request with the first data processor, the request can be entirely built and/or checked prior of being used for authentication with the website, advantageously avoiding a maliciously built request. By checking the website server's certificate in said first environment, it's advantageously avoided to send the password to a different website than the one expected by the user. Sending the HTTP request from the first computing environment to the website server allows to obtain an authentication data representative of the login session, thus advantageously using the security of the communication channel between the website and the first computing environment. Since it's further considered to prevent revealing the password to the browser running in the second computing environment, the password is advantageously kept secret, and then preforming the browsing based on the obtained authentication data representative of the login session allows the established login session to be browsed with the browser, advantageously enabling as result, the login operation being carried in the first computing environment without leaking sensitive information but at the same time the login session is browsed taking advantage of the powerful resources of the second environment.

By having in the user interface a second data processor having at least an interface for controlling an input device, an output device and a first wireless module, it permits that kind of devices for being used besides not being originally considered to be connected only to the user interface, so the user can advantageously make use of them when required, possibly conveniently reusing existing devices that are able to be used from an environment different than the trusted environment. Anyways, as an added benefit, such devices can be trusted themselves when controlled by the trusted environment.

If the output device is a first display, the user can advantageously see data regarding the login operation, and including a sound device the user's attention can be favorably called even if not seeing the display.

If the input device has at least a button, the user can use it for entering the PIN, or confirming the login operation, advantageously avoiding to enter the sensitive information in another environment. The use of a button requires a positive intent from the user since they're conveniently operated by means of a movement operation from the user.

If the first data processor comprises a microcontroller, the device can be implemented in a low-cost fashion and small. If the first computing environment is implemented as a first computer platform including the first data processor, the temporary memory and, the non-volatile memory, a very secure implementation can be achieved as an additional advantage to the user.

If the user interface is integrated into the first computing platform, a very compact implementation can be achieved, and if networking the user interface to the first computing platform is selected, using a separate implementation provides the convenience of the user interface being detachable from the first computing platform, and the trusted environment being robust to attacks if using a secure channel between them.

The first computing platform design considers having a second wireless module, so the user can advantageously use the first computing platform with greater mobility with respect to the standard platform (i.e. not needing to make a wired connection to the secure platform). If the second computing environment is implemented as a second platform such as one having computer like a PC controlling a second user interface like a big monitor, the user can take advantage of an existing and powerful platform, without need to trust it for the sensitive login operation. Also, getting the intrinsic convenience of a hardware-implemented security barrier since each platform can have its own memories each on a different hardware memory bus.

If the computing platform has a network resource capable of performing the connecting to the website, it can be advantageously used to connect to the website, without the network resource being a need to be present in the first platform (since that could make the first platform bulky, expensive, and power hungry). An additional advantage is that the full bandwidth of the second computer platform can be re-utilized.

If the first data processor is configured for using a random string based on a physical random number generator on said first computer environment (for generating the password), the advantage is that the password is more difficult to guess. By implementing the second platform as a PC or a mobile device, the user can make use of existing devices in which the browsing experience can be familiar, comfortable, and efficient. If the user interface includes the input device, the output device and the second wireless module, a more compact and secure implementation can be realized.

If the login operation data consist essentially of the combination of said password and said username, a great number of existing websites can be browsed without requiring the website to change the authentication scheme. Convincing the website operators to change to use a different authentication scheme can be hard to achieve, since it can take so much time and organization efforts, not counting the huge economic impact.

If a secure channel is based on the first wireless module and said second wireless module, the channel doesn't need to be based on wires so the devices could be easily separated.

If the first computing platform is transportable, the user can have it at any time and can have better control of who is using it and when. For achieving that, the device can be just another part of a key-chain usually transported by the user.

If the deciding step is based on confirming the login operation based on information shown in the user interface, the user can advantageously know the details of the operation prior to be accepted, and since the information is shown in a trusted environment, the user can be confident about it. If the information shown comprises an identification of the website server being connected to, the user can advantageously know he's not sending information to an unwanted website.

If the deciding step is based on confirming automatically the operation based on a whitelist, the user can sometimes skip entering a confirmation in the user interface, and instead use a preselected decision.

As another option, if the deciding step is made when the user attempts the login based on the user confirmation, the user can securely confirm the operation in the exact moment it's going to be performed so it's infeasible that malware is triggering the operation without user consent.

If the non-volatile memory is capable to act as a flash storage drive, the user can advantageously store trusted software used for browsing, or for example store an entire operating system with trusted software and configuration, to be used to boot a PC or similar system and thus achieve the desired security level. The storage drive could have a read-only portion (such as a partition or folder) so the user can be confident on the stored software even if used in an untrusted environment that attempt to modify it. Alternatively, the user can use the storage to have encrypted data (for example also depending on the PIN), thus using the device as a more secure option than a standard pendrive. Even if not using the device acting as flash drive for storing sensitive data, the advantage is that the user doesn't need to transport another storage device, for example the pendrive can be removed from the key-chain.

As an additional benefit, if the password is a password to be remembered, a password for repeated use, a password for being recalled or similarly any kind of static passwords, all the websites using that kind of passwords can be browsed in a secure fashion as described without changes to the website.

Regarding the website responses, if the browsing receives the responses directly from the website to the second environment, there's no need in the first environment to be active at all times, so it can save resources, like for example power. Also the need of having the first environment connected to the second environment or requiring manual connection to the second environment vanishes, and overall the full bandwidth of the website to browser connection can be used. In a similar fashion, if the browsing sends requests directly from the browser to the website, similar advantages can be obtained.

If while browsing is considered displaying the browsing results in the second user interface, it can be re-utilized whenever preferred, releasing the need of having an equally suitable user interface on the trusted platform.

A way of securing the password is considered, based on encrypting with an obtained first SSL/TLS session key said HTTP request having inserted therein the password, and obstructing the first SSL/TLS session key to be known in the second environment. That way the request can be safely delivered to the website possibly through the second environment (since it's infeasible in the second environment to obtain the request in plain-text) and as possible added benefit, considering the reusing of the powerful networking resources that the second environment can provide.

It's also considered to carry the browsing obtaining in the browser a second SSL/TLS session key, that way the website can be further browsed in a secure fashion since for obtaining that second SSL/TLS session key the browser can establish a new and secure SSL/TLS connection on its own, without requiring the first environment to reveal previous keys that could be otherwise maliciously used to obtain the password. Alternatively that second SSL/TLS key is obtained by carrying a SSL/TLS session renegotiation operation, that can be initiated in the first environment for example by using the previous connection's parameters, and passing the required renegotiation results to the browser. That way an advantage is obtained regarding the TCP connection (possibly being reused) and expensive asymmetric cryptographic operations saved.

An added convenience regarding the security of the proposed solution, including the protection of the password, is by controlling the software running on the first computing environment by not allowing the execution of non-authenticated software. That way it's more difficult to the trusted platform to be successfully attacked, even regarding the normal security updates that frequently are needed in browser and operating system software since they run in the untrusted environment. Since the first environment is normally not intended to run as many applications as the untrusted environment, requiring all-signed software in the trusted environment can be of little or zero trouble to the user in order to obtain the benefit, at least compared with the untrusted environment. The design considers to apply software and/or hardware attestation (including remote attestation) to attest the first environment, as for example the attestation techniques explained in the book “Trusted Computing Platforms: Design and Applications” by Sean Smith (ISBN-13: 978-0387239163). It's also considered to apply the attestation to the first environment alone, or a different attestation scheme for the first environment than for the second environment (including attestation being different since based on different keys identifying the user). As an example of different security scheme, is performing software attestation in the second environment which is able to read/write program code and data, but in the first environment having attestation software being configured not to be able to read the password database, and only capable of reading program code. Another example is a malware detection software in the second environment, and just checking the signature of software in the second environment prior to execution. In the case of software signing, it is also considered in the design, requiring always the user confirmation through the UI prior to software updates, where in the second environment the software updates can be automatically done in background.

If authentication data representative of the login session comprises a first cookie, there's the big advantage of being compliant with standards ways of managing sessions, so no changes to the website server are required.

If the connection is done from said first environment point-to-point to the website server, there's no feasible way of the connection to be attacked from the second environment.

If the first data processor is configured for modifying the HTTP request to set the username, the login request can be advantageously checked using any security criteria established on the trusted environment, and there's no need to trust the browser regarding the username being used in the login operation.

In a set of particular embodiments the password can be obtained in many ways, as follows:

If obtaining the password is carried by deriving the password from data consisting essentially of said main secret and an URL, a need of using a password database is avoided, thus saving storage resources and need of maintenance of the database. If instead also the username is used, the same can be achieved for different usernames. If obtaining the password is carried by decrypting the password using a PIN entered in said user interface, there's the inherent advantage of being difficult to obtain the password in plain text while the PIN is not known, so in case the password was stored in the device representative of the first platform (and lost), an attack it's more difficult to succeed. If, alternatively, obtaining the password is carried by deriving the password from data comprising a main secret being stored in said non-volatile memory, the password can be very strong since the main secret can have a lot of entropy, and if that secret is encrypted with the PIN similar advantages as using the PIN for encrypting the password are obtained. It is considered that the PIN consist of all or any subset of characters, such as numerical, alphanumerical, of symbols. Reduced characters sets (such as numbers only) may be preferred to reduce the complexity of the trusted input user interface. For personal identification it is also considered the use of an electronic ring (or any other wearable electronic device) instead of (or in conjunction with) a PIN. When user authentication is required and proximity between the Dock/UI and the ring is detected by either the UI/Dock or the ring, a user authentication protocol is automatically started for the ring to authenticate the user with the UI/Dock. Proximity is detected using a near-field wireless network interface both in the Ring and in the Dock (and/or UI). If obtaining the password is carried by searching the password by matching with the username, a password specific to that username can be found so multiple usernames can be used. If, as another option, obtaining the password is carried by using a password database, any kind of password can be used, for example complying with the specific rules of each website. It's considered the password database not being centralized for unrelated users, so each user can manage its own password database and a successful attack for a user can be not used against other users.

If the first data processor is configured for obtaining the username from a field of said HTTP request, there's the convenience that the user can be obtained from the browser, for example in as part of an auto-completed field. If the first data processor is configured for receiving the HTTP request from the browser, it can be decided in the first platform if the request should be sent to the site, if some data such as request fields could be used, and if the request needs to be modified for example first determining the authentication parameters (such as the password or a cookie being inserted).

If first data processor is further configured for tracking a plurality of established login sessions, the user can advantageously browse multiple simultaneous login sessions and manage each separately. If the first data processor is also configured for closing said established login session, the user can be confident the established session is closed or not, since malware in the untrusted environment could make appear the established session is closed when it's not, for later malicious utilization of that established session.

If the first data processor is configured for changing the password in said website server, there's the advantage that the user can request an automatic change on multiple sites so saving time while being confident the change was carried from a trusted environment. If the first data processor is further configured for counting the login operations for deciding to change the password, the change of password could be automatically triggered, with or without the user knowing it. If in a similar fashion, the first data processor is configured for testing if the password is still valid, there's the advantage that user can know if the password is still operative on a determinate site, for taking preventive actions. Periodic testing could be scheduled for all or for specific sites, and a further configuration for detecting if a password change is unwanted based on that testing could be used to inform the user of the unexpected situation.

If first data processor is configured for managing a plurality of different passwords for each website server, the advantage is that a determinate website with multiple login points could be supported. Alternatively the user could manage multiple identities for same website or same login point. If the first data processor is also configured for showing the result of said login operation on said first display, there's a convenience regarding the user can be confident if the login was successful or not, and possibly the reasons. If the first data processor is configured for building and presenting the websites server in a menu, it can be easier to the user to do the login operation for frequent or favorite websites. If that menu is presented in one the browser, it can be helpful to the user since the display used with the browser could be more comfortable, and anyways the trusted platform could be used for confirmation or to see the results of the login operation. If instead the menu is presented in the user interface of the trusted platform, the user doesn't need to rely on the standard an possibly insecure environment at all, with the added security benefit.

If the second environment is configured for running a routing software module that lets each of the first and second computing environments make a plurality of connections to the website server, there's an advantage regarding the routing module can be used to manage all the connections to the website(s), even if simultaneous. The module can conveniently route the even connection used for the login operation.

If the routing software module is further configured for routing HTTP request generated by the browser, depending on an evaluation, to the first computing environment or to the website server, doing that has the advantage of only using the first computing environment when needed, sending if possible the request directly to the website for saving resources or for other reasons. If the evaluation is by matching a preconfigured URL pattern, the requests to some websites could be automatically skipped from being handled by the trusted environment. If the routing software module is further configured for redirecting any half-duplex stream of said plurality of connections to the website, from the first computing environment to the second computing environment, having the upstream and downstream split has the advantage that resources can be saved even in the case just one stream allows redirection skipping. For example if downloading a file, all the downstream could be handled by the second environment, completely skipping the first environment.

Transforming in the first computing environment said authentication data representative of the login session to obtain a transformed authentication data also has additional advantages, as follows:

By securing the authentication data representative of the login session for not being revealed to the second computing environment, the user is confident that malware on the second environment cannot use the login session for doing unwanted operations. Sending the transformed authentication data to the browser is sufficient for carrying said browsing step in second computing environment by basing the browsing of the established session on the transformed authentication data, since the posterior possibility of obtaining in the first computing environment the authentication data representative of the login session associated to the transformed authentication data received from the browser. By then inserting in the first computing environment the authentication data representative of the login session in a second request header to be sent to the website server, that results enough for the login session to be safely browsed, with the sensitive data not being revealed to the browser. The simple operation of cutting communications between the first and second environments is a safe measure for being confident that malware on the second environment cannot do harm, regarding the established login session.

If the first data processor is configured for replacing in a response header received from the website the authentication data representative of the login session with the transformed authentication data for obtaining a modified response header to be sent to the browser, that advantageously avoids the sensitive data for being revealed to the browser while anyways permitting the browsing in a very natural way.

In the case the transformed authentication data is another cookie, adhering to that kind of standards can also make the browsing virtually the same as with prior systems.

If obtaining in the first computing environment the authentication data representative of the login session is based on using as the transformed authentication data an encrypted version of the authentication data representative of the login session, there's no need of using storage on the first environment so any number of connections can be handled. Alternatively, if the choice is using the transformed authentication data in a lookup operation, an advantageously simple scheme is achieved.

As an additional security measure, if the first data processor is configured for securely erasing, after a third request for closing said established login session the authentication data representative of the login session, it's difficult for an attacker to have access to the first platform to get that authentication data (even if breaking the system), thus being that as similar objective achieved by securely erasing the transformed authentication data.

An alternative embodiment comprises a trusted computing environment (where a computer environment basically comprises a memory, or a subset of addressable memory space, accessible by a computer algorithm), the trusted computer environment having access to secure storage such a memory device, the accessing is for example by a wired memory bus, the trusted computer environment also has access to a user interface capable of input and output, for example a touchscreen-display combination, with the display working as a showing device. The trusted computer environment can be further connected to a untrusted (i.e. standard) computing environment connection being for example wireless, the untrusted computing environment has access to a untrusted storage such as a memory device, and the untrusted (i.e. standard platform) computing environment has access to showing device such as a display, the access being for example by an HDMI interface. The secure (trusted) and untrusted computer environment can also have processing means that could be the same or different, and any or both of the environments can also have means to access a service provider such as web server provider, the service provider being able to process a set of service requests each of different kind and to produce a response as result of such requests (requests and responses capable of being generated and received from the trusted computing environment) where some but not all of the possible service requests may belong to another set of selected operations (thus forming a noninclusive subset), thus permitting generating a selection of operations considered deserving higher security than others. The access to the service provider can be for example by HTTP protocol over a network interface. There's a security barrier between trusted (such as the secure platform) and untrusted (such as the standard platform) storage means, for example implemented in hardware by using different wired memory buses connected to a different memory bank for each environment, and two CPUs each connected to each memory bank. The security barrier can be implemented in software, for example by utilizing a memory protection unit of a processor shared by the two computing environments.

There's user credential data, the user credential being for example a combination of an user id and password, the credential being stored in the secure memory. In the trusted computer environment there's software configured to authenticating the service provider, for example by checking the server's certificate. The software on the secure environment can access the stored user credential, and if a condition is met the credential is sent to the server. Then information is derived from the responses generated by the server (for example as part of the response text label and its formatting data), where this data can be temporarily or permanently stored on the untrusted computing environment memory. Interpreting that responses, the untrusted computing environment is able to render on the display an image corresponding to that information (such as the text label with its formatting data being drawn appropriately).

The trusted computing environment can be further configured for receiving one or more responses from the service provider. In the response, one or more occurrences of authentication data generated by server can be identified, for example when the authentication data is one or more HTTP cookies. From the received authentication data, new authentication data can be generated for example by hashing the received authentication data or by applying a derivation function, thus generating derived authentication data. There are other possibilities for the construction of the new authentication data such as:
a) Using table look-ups. This is a function from an index space to the space of received authentication data.
b) New authentication data can be encryption of the received authentication data. This corresponding function is the decryption function.
c) New authentication data is a hash of the corresponding received authentication data. The function is a lookup on a special data structure, preferably a sorted tree.
d) The new authentication data is equal to the received data. This is the identity function.
e) A combination of the above or other functions

A modified response is generated by replacing the occurrences of received authentication data with the newly generated authentication data. The modified response is then sent to the untrusted computing environment. The untrusted computing environment, by analyzing the modified responses, can control the display for visualizing a representation which depends on the modified responses.

The trusted computing environment is capable of accepting services requests from the untrusted (i.e. standard platform) computing environment. If in the accepted service request there are occurrences of the generated authentication data they are replaced with the corresponding server's authentication data to generate a modified request. Then the trusted computing environment identifies if such requests meets a condition, where the condition can involve evaluating whether the request correspond to a (possibly noninclusive) subset of all the possible operations, and the condition can also involve identifying if the user corresponds to a particular user by looking to the server's authentication data, and also the condition can further involve asking the user to confirm the operation, so based on the condition a decision is taken regarding if the modified request should be sent to the service provider or not. Then it is identified if such requests correspond to the subset of selected operations, while optionally identifying if the user correspond to a particular user by looking to the server's authentication data, and if one or both conditions are met, the user is asked to take a decision of whether the modified request should be sent to the service provider or not. It's considered also a server running in the trusted computing environment.

Common servers for dumb terminals basically formats all the information for being interpreted to be then shown by the terminal client (the information being for example a character string and font formatting to be rendered in a GUI) while in case of a server for a client smarter than a dumb terminal, that server for the smarter clients can forward from another server some or all the information for being interpreted and shown, so that another server is the one that formats the information for being interpreted to be shown by the smarter client. The information can be sent by forwarding it unchanged or by first building a version which produces equivalent rendered output, in any case provided that information is accessible by the untrusted (i.e. standard platform) computing environment (for example by reaching its associated storage).

It's considered an intermediate rendering step, between interpreting the information and showing it, and is further considered that no rendering of the information is carried in the trusted (i.e. secure platform) computing environment with the advantage of saving processing resources, or at least to partially offload rendering to the untrusted (i.e. standard platform) computing environment.

Also, some of those smarter clients can be configured for being capable of aggregating the information for being interpreted to be shown from various sources and most (if not all) of the times the information gets mixed in a single user interface (or UI portion) in a way that makes difficult when not impossible to distinguish the source by just looking the rendered output. It's considered for embodiments, the use of a server configured to work with that kind of dumb clients, or for terminal clients, or for that kind of smarter clients, or for a more complex browser client, or for a combination of the described clients. There are also considered as options, the forwarding of all the information to be shown corresponding to a particular authenticated session, or to all sessions, and it's also considered partial forwarding, and the forwarding from various sources, or a combination of those options. Thus, it's considered implementing a server that can sit in the middle between a client and another server and also able to forward, or to build, or to aggregate from various sources (or a combination of those options), information to be shown by the client. That kind of middle server can run in the trusted computer environment while that kind of clients can run in the untrusted computing environment. Since both the middle server and a client can be complex pieces of software, it's considered that they use storage for maintaining state such as RAM memory, but for security reasons the storage is separated for example by a security barrier, with the separation done by networking the client and server wile each runs on different processors having each local memories, or by using logical memory protection if the client and server runs on a processor system that access the same physical memory.

It's worth to be appreciated that a service provider response may contain one or more elements to be shown (“visual” elements, or information whose protocol defined purpose is to be used for generating a graphical representation, like an HTML tag to display an image) and a browser such as web browser is typically capable of discriminating in the response those visual elements from other non-visual elements (an example of a non-visual element being an HTML cookie), and such browsers are also typically capable of interpreting the contents of such visual information, and further such browsers are typically further capable of actually generating the visual representation (that is, rendering the information), while at the same time such browsers are typically capable of sending the rendered information to a display. In the present invention it's considered the possibility of carrying in the trusted computing environment the following operations: the discrimination of visual information done over a portion of the response, or over the whole response, or just skipped, while also being considered that the interpretation of the visual elements is done in a portion of the response, or in the whole response, or just skipped, while also being considered the rendering of the visual information being done in a portion of the response, or in the whole response, or just skipped, while also being considered that the sending of the rendered information to a display can be done in a portion of the response, or in the whole response, or just skipped, while also it's further considered that what's is partially or totally skipped, to be carried in the untrusted environment thus advantageously offloading the operation(s). It's further considered similar partial or total offloading mechanisms for other kind of elements in the responses to be consumed by the user, such a file to be downloaded, the way to make available the information from the service provider to the untrusted computing environment, can be by sending it from the trusted environment, or by allowing the untrusted computing environment to directly get the data from the service provider, for example by a connection that skips the trusted computing environment.

Other possible embodiments considers: 1) to pass cookies (persistent/no-persistent), 2) to renegotiate the session, and not to renegotiate and keep the MAC key private (a solution works if uses Diffie-Helman protocol, but may not work equally if uses RSA).

The proposed device has, in one of its preferred implementation, two parts:

Part 1 “UI” device having: A 32-bit microcontroller, with the microcontroller having an LCD control interface, Communication interface with BLE module through UART, Crypto accelerator of modular exponentiation, elliptic curve multiplication of the group (F2p, AES, SHA-1, SHA-2), Enough RAM and FLASH memory, DAC (Digital Analog converter), SPI communication interface (x2) for accelerometer and charge module/battery information, Interface for activation detection of capacitive buttons, Real Time Clock (RTC) Module, Hardware Random Number Generator Module. The UI also has Accelerometer with SPI interface, Audio amplifier, Speaker, LCD display, BlueTooth BLE with high-speed UART interface, microcontroller and enough RAM (to fit data in order to buffer and be able to communicate to other microprocessor the buffered data, using for the communication a short duty cycle, short in the sense that the needed power for communication of packets of a BlueTooth given size be less than the microcontroller consumption for receiving or communicate suck packets, the size in relation to the headers size of the HTTP protocols)

The “UI” also has Battery with circuit for charge and measurement, and delivering by SPI status information, Male connector for transmitting to “Dock” module the lines of power supply and serial data (4 lines in total).

The other part (Part 2 or “Dock”) device has: A 32-bit microcontroller with low power modes. The microcontroller having Crypto accelerator of modular exponentiation, elliptic curve multiplication of the group (F2p, AES, SHA-1, SHA-2), Enough FLASH and RAM memory, Communication interface with BLE module through high-speed UART, DMA for the UART interface and associated interrupts which allows to exit the low power modes, USB communication interface for the connection with USB host, SD memory communication interface. The Dock also has RGB led, BlueTooth BLE module with UART interface, USB Standard-A plug, Female connector for transmitting to “GUI” module the lines of power supply and serial data (4 lines in total), SD memory socket, SD Memory

It's further considered an embodiment wherein the Dock and UI can be hooked, the detection of activation with a capacitive keypad, and that the UI asks the website password corresponding to the user and pass it to Dock. Also, it's considered an implementation having a communication interface with an SD memory, the use of an USB Standard-A plug, a socket for SD memory, and the use of an SD memory.

Another possible implementation of the invention works as follows: The dock is configured so all communication with the UI being secure (at least encrypted and authenticated). The PC is configured for having a “multiplexing system” that allows the Dock to perform connection to the Internet. The PC needs to keep a record regarding if the responses over such connections are for the Dock or to the PC for sending it to the corresponding target. Initially the responses of the connection created from the Dock are for the Dock. It is inputted the PIN in the “UI”

The special browser is run in the PC, the browser allows that the dock communicates to internet through HTTPS protocol (point to point from the dock to the website)

The dock always check the certificates of the HTTPS connections through a database of root CA certificates and aborts the connections that don't authenticates the server

The Dock also checks revoked certificates to decide if allowing or not the HTTPS connection.

The PC through the browser sends a web request to the dock

The dock identifies if the request corresponds to a login to a website The identification is performed by analyzing the HTTP request (for example the URL, the host, the cookies or the POST variables). This analysis can use a pattern database. Depending of that executes one of two:

1) If the request corresponds to a login: The dock ask the UI the website password. The UI decrypts (using the PIN) a database with the passwords of different websites, obtains the password from the website corresponding to the user, and pass it to the dock. The dock connects to the website making the PC to receive and forward to the website the encrypted packets, the dock executes a login request conformed by the dock. If the request corresponds to a login, alternatively the following can be done:

Dock determines the name of the user that attempts to login. For that checks the pattern database to identify the field having the username. If there's no information on the pattern database the username related with such website, previously stored in the Dock memory. If a pattern exists, such name is extracted. If the name is not specified, the Dock assumes the username related with such site, previously stored in its memory.

The UI decrypts a deriving secret with the PIN used as key.

The UI searches, based on the fields already available for login, the password in a database (eventually encrypted with the deriving secret and decrypted in the UI).

If not found, a password is generated on-the-fly based on the deriving secret and the login data, by a key-derivation-function.

The UI passes the password to the Dock.

The Dock connects to the website making the PC to be ready to receive and forwarding to the website the encrypted HTTPS packets. The Dock makes a login request HTTP/HTTPS internally built. Alternatively, the Dock connects to the website by a new SSL/TLS connection or re-utilizing a pre-existent connection of a connection pool.

Depending of a configuration, if the request requires conformation or not (which can depend on the site or the operation kind) the login operation can require a conformation of the following way:

The dock sends data of the login request in question to the UI

The UI shows data identifying of the request and waits user confirmation

The UI sends the response of the user to the dock

If the answer is negative, the dock aborts the operation, optionally returning an error code to the PC

In the dock it is being registered one (or various) cookies or other parameters identifying the corresponding web session (such as a hidden field) that are obtained as response to the login request, conforming the cookie(s) or other parameter identifying of the session, a “web-session-id/cookie” or otherwise calling them individually or collectively Session-Authenticator.

Once obtained a web-session-id/cookie, it continues of the following way:

Depending on a configuration condition (that can depend on the web site in question) that determines if the cookie (or Session Authenticator) should be passed to the PC (or not) in a way that the PC can know the plain text, one of two is executed:

As option 1 of the condition:

1) if the Session Authenticators are not passed to the PC

The dock builds one of more parameters (that can be cookies, hidden fields or of another type) that allow retrieve uniquely the Session Authenticators based in its presence inside the HTTP requests posterior or associated with them. This cookies/hidden/fields/parameters will be called Locators.

The Locators are build according to any of that ways:

The Locator is an ID that references a Session-Authenticator stored in the Dock.

The Locator has the information of a Session-Authenticator in authenticated and encrypted way by private keys of the Dock.

The Dock sends the Locators to the PC.

The browser associates each Locator to a domain or sub-domain or URL, and eventually to a browser user profile, in similar way as the cookies.

The PC builds any number of HTTP/HTTPS requests according to the browser operation.

For each request built, the PC first analyzes it to determine if it has or doesn't have Locators.

If doesn't have, the PC send the request directly to the website without passing through the dock.

If it has: The PC sends the requirement to the dock in order that the dock can know the plain text of the request.

Just after the Dock receives the request header, the Dock starts his analysis for building an “authenticated header”. If there are no Locators, aborts.

Initially, all the request header is copied to the “authenticated header”.

All the present Session-Authenticators are discarded to avoid the mix-up of authenticators.

For each Locator in the header, the dock: Interprets it. If malformed, or cannot be authenticated, aborts.

The dock inserts the Session-Authenticators corresponding to the Locator.

The dock opens a new SSL/TLS connection to the website (that can be conventional or an abbreviated SSL/TLS handshake or other kind of handshake that avoids asymmetric cryptography), or reuses a connection from a pool of open connections, sends the authenticated header to the website keeping open the connection and eventually part of the body that has been received.

As option 2 of the condition: 1) If the cookie is passed to the PC: The PC executes new web requests specifying the cookie, direct from the PC to the website (without passing through the dock) 2) If the cookie is not passed to the PC: The PC sends all the HTTPS requests to the dock in a way that the dock can know the request plain-text

If the request header has a web-session-id/cookie that is sent by the PC, the dock replaces it with the one obtained with the password.

The request can be considered “big” according to a condition. The condition of “big request” can be, for example, since the size in bytes is above a predefined threshold, the size in bytes can be deduct from the corresponding header or be counted as it is being received According to if the request is considered “big”, it executes one of two:

1) If the request is not big: The dock sends to the website the rest of the request following the header

2) If the request is big: The dock renegotiates the HTTPS connection parameters (by means of a renegotiation of parameters SSL/TLS which can be by the recent protocol of secure negotiation or the previous insecure, depending on the server capabilities that can be analyzed in that moment or previously)

The renegotiation can be reusing a session previously renegotiated. The dock sends the renegotiated connection parameters that allows the PC to continue sending the request, avoiding the corresponding packets from the PC to the website in direct form

The PC receives the website responses, of which can obtain the plain-text or not, and depending on that it is being executed one of two: 1) If the PC can obtain the plain-text, process the response and updates the browser correspondingly 2) If the PC can't obtain the plain-text, it passes the response to the dock: The dock analyzes the existence of a web-session-id/cookie in the response as it is being received, in which case it is being executed one of two: 1) if exists a web-session-id/cookie in the response, the dock updates the previous web-session-id/cookie in case of being different 2) If not a web-session-id/cookie in the response

The dock sends what received to the PC in a way that the PC can interpret that.

The response can be considered “big” according to a condition: the condition of “big response” can be, for example, since the size in bytes is above a predetermined threshold, the size in bytes can be deduct from the corresponding header or being counted as it is being received.

According to if the response is considered “big”, it is being executed one of two: 1) If the response is not big, the dock sends what is remaining to be sent of the response to the PC in a way the PC ca interpret that

2) if the response is big, the dock sends what is received of the response to the PC in a way that the PC can interpret that. The dock renegotiates the HTTPS connection parameters (by means of a renegotiation of parameters SSL/TLS which can be by the recent protocol of secure negotiation or the previous insecure, depending on the server capabilities that can be analyzed in that moment or previously). The renegotiation can be by re-utilizing a session previously renegotiated. The dock sends the renegotiated connection parameters that allows the PC to continue the reception of the packets, receiving the corresponding packets from the website to the PC in direct form.

The PC interprets the received response and updates the browser

Alternatively, also the following can be done:

Not just the response but also the request body can be considered “big” according to a condition.

The condition of “big body” can be, for example, since the size in bytes is above a predefined threshold, the size en bytes can be deducted from the corresponding header or be counted as the body is being received. Also by configuration it's possible to never determine that the body is “big”.

According if the body is considered “big”, one of two are executed.

1) if body isn't “big”. The dock sends to the website the body part of the request still not sent, and possibly the connection is stored in a pool of open connections.

2) if the body is “big”. The dock executes the handshake of the TLS/SSL protocol to renegotiate new security parameters (master secret) of the SSL/TLS connection already opened. The renegotiation can be done in a conventional way to re-utilizing a session previously negotiated (abbreviated handshake or other kind of handshake that avoids asymmetric cryptography). The dock sends the connection parameters (keys) renegotiated, that allows the PC to directly send the rest of the body. In that way Dock resources can be saved. The connection parameters sent can be total or partial. If partial, the following three are considered: client_write_MAC_key, client_write_key, client_write_IV.

The PC receives response packets from the website and derives them to the dock or Browser according to the multiplexing system. Depending on that one of two are executed: 1) If the response packets are for the PC, the PC process the response and accordingly updates the browser. 2) If the response packets are for the Dock, it passes them to the Dock.

The Dock receives the response header and analyzed the existence of a Session Authenticator on such header, in which case one of two is executed: 1) If a Session Authenticator exists in header: The dock updates the previous Session Authenticator. 2) If there are no Session Authenticator in header, two things can be done: 1) The dock receives the body of the response and sends which was received to the PC in order for the PC can interpret it. If the keys for sending data client->server of the connection weren't sent by the Dock to the PC previously, the Dock stores that connection in the pool of opened connections. 2) The dock analyzes the header and determines in the body is “big” (in a similar was as previously described) 1) if the response is not big: The dock receives and sends the body to the PC in a way that the PC can interpret it. 2) if the response is “big”: If the keys for sending data client->server of the connection weren't sent by the dock to the PC previously:

The dock executes the handshake of the SSL/TLS protocol to renegotiate new security parameters. The renegotiation can be done in conventional form or re-utilizing a session previously negotiated. The dock sends the (for example, renegotiated) connection parameters (keys) that allow the PC to receive the rest of the body. This is done changing the multiplexing table.

The PC receives the corresponding packets directly from the website. In that way Dock resources can be saved. The connection parameters sent can be total or partial. If partial, they can be: server_write_MAC_key, server_write_key, server_write_IV.

The PC interprets the received response and accordingly updates the browser.

In regards to the database of patterns, it can: Be dynamically downloaded from Internet and cached in the Dock/UI or Kept always stored in Dock/UI, or Dynamically built (learning mode). This latter requires: Login page detection. Manual login: The browser has an option to use the URL presently visible. Automatic login: A page with a field of type password is detected.

Detection of the GET/POST requirement of sending the password for login and field for password input:

Manual: the user enters the login page, and inputs an arbitrary text as password and accepts. Automatic: A request with a field having and ID corresponding to a password field (input-type=“password”) in the login HTML page. Semiautomatic: the user enters as password in any field a word or part of a reserved word for such effect.

The mechanisms used presently by the browsers for detecting and remembering fields with passwords.

Detection of the cookies that are related with user authentication:

The cookie detection that belongs to the authentications can be done analyzing the ones that are HttpOnly.

Detecting the cookie changes before and after login.

The dock can additionally store in a secure way the password used while manual login (possibly insecure) as the password associated with that site.

The PC memory can work as an extension of the memory of the Dock/UI in the following way:

When the Dock/UI requires to download a data record, it builds a data packet containing that record in a way that can be identified and be asked, encrypts it and authenticates it. Then sends it to the PC jointly with its identification. In the PC an special application stores it permanently or temporally.

When the Dock/UI requires access to that record again, sends the identification of the record.

The PC returns the requested packet and the Dock/UI authenticates and decrypts the packet, obtaining the original record and also verifying the correspondence of the identification of it.

The dock ask to send packets for being stored in the PC, When the amount of own memory available gets below a pre-configured limit, When the user asks explicitly to make a dump of records,

and/or When time a preconfigured inactivity time elapses.

The records to be sent can be selected automatically based on a condition, for example: If the record size is above a predetermined value. If the time elapsed is above a predetermined value.

In another embodiment, the invention is implemented with steps as in FIG. 20:

In the NETWORK SETUP 5800 step, Dock is configured in order that all communications with the UI is secure (at least encrypted and authenticated).

In the STREAM MULTIPLEXING 5801 step, the PC is configured for having a “multiplexing system” that allows the Dock to make connections to the Internet. The PC must have a record regarding if the responses over such connections are for the Dock or to the PC for sending them to where them corresponds. Initially, the responses of the created connections from the Dock are for the Dock.

In the PIN INPUT 5802 step, the PIN is inputted in the “UI”.

In the SERVER AUNTENTHICATION 5803 step (option 1) the special browser is executed in the PC, the browser allows the Dock to communicate to the Internet by the HTTPS protocol (point-to-point from the Dock to the website). Alternatively, as SERVER AUNTENTHICATION step (option 2), The browser creates a HTTP/HTTPS request, and a the FILTER REQUEST step to determine the target of the response.

In the SESSION REQUESTS step, the PC by means of the browser sends a HTTP request to the Dock.

In the REQUEST ANALISIS 5806 step, the Dock identifies if the request corresponds to a Login to a website. The identification is performed by analyzing the HTTP request (for example the URL, the host, the cookies or the POST variables). This analysis can use a pattern database. If it's a login, the LOGIN step is run.

In the SESSION REQUESTS 5805 step, the PC builds any amount of request HTTP/HTTPS according to the browser operation.

In the TRANSFORM HEADER 5822 step, new cookies are created in temporary space by using pre-defined functions. New cookies can use inputs from the cookies specified in the header, a predefined set of cookies are removed from header, and the created cookies are copied from the temporary space to the header.

In the TRANSFORM BODY 5823 step, the HTML BODY is parsed, and it's

Executed a predefined set of BODY transformation functions.

In the FILTER REQUEST 5804 step, The HTTP request are sent directly to the Internet, the PC analyzes the HTTPS requests, and depending on if it has Locators and if the Dock is configured to receive all the HTTPS access, the following is done: If there are no Locators and the Dock is not configured for receiving everything: the request is send directly to the Internet and the response is response is processed normally, or if there are Locators or the Dock is configured for receiving everything: the request (or at least the header) is sent to the Dock in a way that the Dock can access to the plain text.

In the SERVER AUNTENTHICATION 5803 step, the Dock always check the certificates of the HTTPS connections by a database of root certificates, and aborts the connections that do not authenticate the server.

The dock also checks revoked certificates to decide if allowing or not the HTTPS connection.

In the REQUEST ANALYSIS 5806 step, its evaluated if the request corresponds to a Login, if yes, the LOGIN step is run. If not, it can send it to the PC as a possible option.

In the LOGIN 5807 step, the Dock determines the name of user that is attempting to login. For that, checks the pattern database to identify the field of the user name. If there is no information in the pattern database, it's used the username related with such website, previously stored in the Dock memory. If there's a pattern, extracts such name. If the name is not specified, the Dock assumes the username related to such website, as previously stored in its memory. The UI decrypts a deriving secret with the PIN as key. The UI searches, based on the fields already available for the Login, the password in a database (eventually encrypted with the deriving secret and decrypted in the UI). In case of not being found, the password is generated on-the-fly based on the deriving secret and the Login data, by a key-derivation-function. The UI passes the password to the Dock.

In the LOGIN CONFIRMATION 5808 step (option 1), the Dock connects to the website by a new SSL/TLS connection or reusing a pre-existent connection from a connections pool. The Dock makes a HTTP/HTTPS Login request built internally.

In the Dock one (or several) cookies or other identifying parameter of the web session (such a hidden field), obtained as response of the Login request and being called them individually or collectively Session Authenticators, are recorded in the Dock.

Depending on a configuration condition (that could depend of such website), it's determined if the Session Authenticator should be sent to the PC in a way that the PC can know the plain text.

If the Session Authenticators are not passed to the PC, the SESSION AUTENTHICATION MANAGEMENT step is run.

In the LOGIN CONFIRMATION 5808 step (option 2), depending on a configuration, if the request needs confirmation or not (something that can depend on the website or on the operation kind), the Login operation can request a confirmation in the following way:
1. The dock sends the data of the Login requirement to the UI.
2. The UI shows the data capable of identifying the request and waits confirmation from the user.
3. The UI send the user confirmation response to the Dock.
4. If the response is negative, the dock aborts the operation, optionally returning an error code to the PC.

In the SESSION AUTENTHICATION MANAGEMENT 5809 step, the Dock builds one or more parameters (that can be cookies, hidden fields or other types) that allow to recover univocally the Session Authenticators based on its presence within the HTTP request posterior or associated with them. This cookies/hidden fields/parameters will be called Locators.

The LOCATOR CONSTRUCTION 5810 step is for building the Locators according to one of this ways:
a) The dock sends the Locators to the PC.
b) The browser associates each Locator with a domain or subdomain or URL, and eventually to a browser user profile, in a similar way to the cookies.
c) The Locator is and ID that references a Session Authenticator stored in the Dock.
d) The Locator has the information of a Session Authenticator in authenticated and encrypted form by private keys of the Dock.

In the SESSION REQUESTS 5805 step, for each request that is built, the PC first analyzes it to determine if it has or has not Locators: If it has not, the PC sends the request directly to the website, without passing through the Dock (authenticated header results in current header). If it has, the LOCATOR REQUEST PROCESSING step is carried.

In the LOCATOR REQUEST PROCESSING 5811 step, the PC sends the request to the Dock in a way that the Dock can know the plain text of the request.

As soon the Dock receives the request header, the Dock starts its analysis for building an “authenticated header”, as done in the AUTENTHICATED HEADER CONSTRUCTION step.

The Dock opens a new SSL/TLS connection with the website (that can be a conventional handshake or an abbreviated SSL/TLS handshake or other kinds of handshake that avoids to do asymmetric cryptography), or reuses a connection from the pool of opened connections, sends the authenticated header to the website and eventually part of the body that has been received, keeping the connection open.

In the REQUEST BODY PROCESSING 5813 step, the PC receives response packets from the website and derives them to the Dock or to the browser, according to the multiplexing system. Depending on that it's run one of two, if the response packets are for the PC, the PC process the response and updates the browser accordingly. If the response packet are for the Dock, they're passed to the Dock as described in the DOCK RESPONSE PROCESSING step.

In the DOCK RESPONSE PROCESSING 5816 step (option 1), the Dock receives the response header and analyzes the existence of a Session Authenticator in such header. If a Session Authenticator exists in the header: The dock updates the previous Session Authenticator.

The dock analyzes the header and determines if the body is “big” (in a similar way as described). If the response is not big, the SMALL RESPONSE PROCESSING step is carried. If the response is big, the LARGE RESPONSE PROCESSING step is carried.

Another option of implementing the DOCK RESPONSE PROCESSING 5816 step is as follows: first, carry the UPDATE SESSION-AUTHENTICATORS step, then optionally if there is no authenticator it may send the connection to the PC.

Then big or not big responses are processed as described.

In the UPDATE SESSION-AUTHENTICATORS 5817 step, The Dock receives the response header and analyzes the existence of a Session Authenticator in such header. If a Session authenticator exists in the header, the Dock updates the previous Session Authenticator.

In the SMALL RESPONSE PROCESSING 5819 step, The dock receives and sends the body to the PC in a way the PC can interpret it. If the keys for the sending of data client->server of the connection weren't previously delivered by the Dock to the PC, the Dock stores that connection in the pool of opened connections.

In the LARGE RESPONSE PROCESSING 5820 step, if the keys for the sending of data client->server of the connection weren't previously delivered by the Dock to the PC, the RESPONSE RENEGOTIATION is carried. The Dock sends the connection parameters (keys) that allow the PC to receive the rest of the body. That is performed changing the multiplexing table. The PC receives the corresponding packets from the website in direct fashion. That way Dock resources can be saved.

The parameters sent can be total or partial. If partial, they can be the following three: server_write_MAC_key, server_write_key, server_write_IV. The PC interprets the received response and updates the browser accordingly.

In the RESPONSE RENEGOTIATION 5821 step, it's not done if the server doesn't support renegotiation or it's disabled for the website or in a global level or upon another condition.

Otherwise the Dock executes the SSL/TLS protocol handshake to renegotiate new security parameters (master secret) of the SSL/TLS connection already opened.

The renegotiation can be performed in conventional form or reusing a previously negotiated session (abbreviated handshake or other type of handshake that avoids making asymmetric cryptography).

In the LARGE REQUEST BODY PROCESSING 5815 step, The dock runs the TLS/SSL protocol handshake to renegotiate new security parameters (master secret) of the SSL/TLS connection already open.

The renegotiation can be done in conventional way or reusing a session previously negotiated (abbreviated handshake or other type of handshake that avoids asymmetric cryptography).

The dock sends the renegotiated connection parameters (keys) that allows the PC to send the rest of the body. The PC sends the corresponding packets from the PC to the website in direct form. This way Dock resources can be saved. The connection parameters sent can be totally or partially. If sent partially, they can be the following three: client_write_MAC_key, client_write_key, client_write_IV.

In the AUTENTHICATED HEADER CONSTRUCTION 5812 step, If there's no Locators, aborts. Otherwise, initially all the request header is copied to the “authenticated header”. All the existing Session Authenticators are discarded to avoid the mix-up of authenticators. For each Locator in the header, the dock interprets it. If malformed, or cannot be authenticated, aborts. If well formed the dock inserts the Session Authenticators that corresponds to the Locator.

In the REQUEST BODY PROCESSING 5813 step, the request body can be considered “big” according to a condition. The condition of “big body” can be, for example, since the size in bytes is above a predefined threshold, the size in bytes can be deducted from the corresponding header or be counted as the body is being received. Also by configuration it's possible to never determine that a body is big.

According to the condition of the body being considered “big”, one or two is executed: If the body is not big, the dock sends to the website the body part of the request still not sent and eventually the connection is saved in the pool of opened connections. If the body is big, the LARGE REQUEST BODY PROCESSING step is carried.

A further considered implementation is by a system for performing secure operations having two execution environments. The first execution environment being configured for: obtaining a first data able to authenticate an user before a service provider, performing a first set of authenticated operations with said first data through an UI, setting the UI in states indicative of the performing of the first set of operations, obtaining through any of the authenticated operations, a second data able to authenticate the user before the service provider, the second data different than the first, controlling the access to the first data, so other execution environments can know it, controlling the access to the UI, so to avoid that other execution environments set the UI in states indicatives of the performing of the first set of operations. The second execution environment being configured for: obtaining the second authentication data of the first environment, performing a second set of operations authenticated with the second data performing as result of the second set of operation one of two 1) to set a second UI or 2) to set the first UI in states no indicatives of the first set of operations.

Another embodiment is considered, implemented as a computer system having a first computing environment. The first environment is configured to have access to a storage system, to an input/output user interface and to communication system. The communication system is capable of accessing to a second computing environment and to an authentication system. The authentication system is capable of performing an authentication protocol. The first microprocessor is further configured for: deciding upon a first condition whether or not to execute the authentication protocol, the first condition being a user confirmation through the input/output user interface, obtaining credential data corresponding to a user from the storage system; according to the first condition executing the authentication protocol with the authentication system using the credential data to obtain authentication data corresponding to said user, generating a second authentication data corresponding to the first authentication data, and sending to the second computing environment the second authentication data.

In an additional embodiment the first computing environment is further configured for: accessing to a service provider, receiving the second authentication data from the second computing environment, obtaining the first authentication data from second the authentication data, deciding upon a second condition whether or not to send the first authentication data to the service provider, the second condition being a user confirmation through the input/output user interface, and sending the first authentication data to the service provider according to the condition.

A further considered embodiment has the first computing environment configured for: receiving data with visual content from the service provider, off-loading to the second computing environment the total or partial interpretation of the data with visual content, off-loading to the second computing environment the total or partial determination of the graphic representation of the data with visual content, and off-loading to the second computing environment the total or partial rendering of the data with visual content.

In another embodiment the first computing environment is configured to have access to first storage means and to an input/output user interface, and access to connection means to a second computing environment configured to have access to second storage means and to showing means, and there's a security barrier between first and second storage means, and means for accessing a service provider by sending service requests and receiving responses wherein the first computing environment further comprises a data processor configured for authenticating the service provider. The first environment is also configured for obtaining a user credential data from first storage means, deciding upon a first condition whether or not to send to the service provider the user credential data, the first condition being a user confirmation through the input/output user interface, sending the credential data to the service provider according to the first condition, storing on second storage means via second computing environment information derived from the service provider generated responses, and controlling the showing means based on the information stored on second storage means.

A further considered embodiment is implemented with the first computing environment being further configured for receiving a response from the service provider, identifying in the received response a first authentication data, deriving a second authentication data from the first authentication data, generating a modified response by replacing the first authentication data with the second authentication data to, sending the modified response to the second computing environment, controlling the showing means based on the modified response, accepting a service request from the second computing environment, replacing the second authentication data with the first authentication data to generate a modified service request, deciding upon a second condition whether or not to send to the service provider the modified service request, the second condition being a user confirmation through the input/output user interface, and sending the modified service request to the service provider according to the condition.

Further embodiments are considered, with the characteristics as listed below:
a) The user credential data considering a combination of user id and password.
b) The condition further comprising identifying whether the accepted service request belongs to a noninclusive subset of the set of possible service requests.
c) The means for accessing the service provider being one of 1) the HTTPS protocol 2) the HTTP protocol 3) a WAP protocol 4) the TLS protocol 5) the SSL protocol 6) the FTPS protocol 7) the WSS protocol.
d) The means for accessing the service provider being a networking device.
e) The service provider comprising a remote server.
f) Storing on second storage means data to be shown as obtained from the service provider g) Sending to the second computing environment data to be shown obtained from the service provider in an equivalent form for rendering purposes
h) The first authentication data being one of 1) an HTTP cookie 2) an HTTP hidden form variable 3) HTML Web storage 4) URLs strings in links
i) The means for accessing the service provider is through a networking device of the second computing environment.
j) The security barrier comprises at least two memory devices wired on different memory buses.
k) The output interface of first computing environment comprises re-utilizing the display of the second computing environment, and where there is a further indication device controlled by first environment capable of indicating if the data on display is being generated by first environment or not.
l) The first storage means and second storage means are different cells of a single memory storage device, and the barrier is implemented in a logical fashion by a CPU memory protection system.
m) The first computing environment has a microprocessor including a tamper-proof memory as the first storage means.
n) The second authentication data being an encrypted version of the first authentication data.
o) The second authentication data comprises a hash of the first authentication data.
p) The second authentication data being an index to a table of first authentication data.
q) The credential being sent in encrypted form.
r) The user interface shows at time of confirmation being one of 1) an identification of the service provider 2) the user id 3) data of the service request.
s) The showing means being one of 1) display 2) sound device 3) vibration device.
t) The first computing environment discriminates in the responses information corresponding to visual elements.
u) The second computing environment discriminates in the responses information corresponding to visual elements. The first computing environment interprets the information corresponding to visual elements of the responses.
v) The second computing environment interprets the information corresponding to visual elements of the responses.
w) The first computing environment renders the information corresponding to visual elements of the responses.
x) The second computing environment renders the information corresponding to visual elements of the responses.
y) The first computing environment sends to a display rendered information corresponding to visual elements of the responses.
z) The second computing environment sends to a display rendered information corresponding to visual elements of the responses.
aa) The second computing environment can confirm a subset of the operations by using a biometric sensor, such as a fingerprint reader.

An alternative embodiment is considered, in which a first execution environment configured for: obtaining a first data able to authenticate an user before a service provider, performing a first set of authenticated operations with said first data through an UI, setting the UI in states indicative of the performing of the first set of operations, obtaining through any of the authenticated operations, a second data able to authenticate the user before the service provider, the second data different than the first to control the access to the first data, so other execution environments can know it to control the access to the UI, so to avoid that other execution environments set the UI in states indicatives of the performing of the first set of operations, and in which a second execution environment configured for: obtaining the second authentication data of the first environment, performing a second set of operations authenticated with the second data, performing as result of the second set of operation one of two 1) to set a second UI or 2) to set the first UI in states no indicatives of the first set of operations.

More embodiments are considered, as follows. A basic way of realizing an embodiment, as a possible option considered, is by an apparatus comprising at least two computing environments configured to work in combination to allow secure interaction with the service provider. It should be remarked that in all the preferred embodiments, all described interfaces, computing environments and security barriers can each be implemented in hardware, in software, or with an architecture combining software and hardware. For example, the security barrier could be implemented as the barrier between an operating system kernel (supervisor environment) and the user applications (user-level environment), with the supervisor environment corresponding to the trusted environment (first computing environment) and the user-level environment to the untrusted environment (second computing environment) by using a memory protection unit of a processor. Other possible trusted/untrusted environment combination can be:
a) an hypervisor/hypervised environment,
b) two process running with different user privileges,
c) one interpreter and an interpreted code running on the same process,
d) Two program codes running on the same process: a trusted part and a second part that has been verified that cannot access the trusted part, including formally verified code, and code that has undergo static checking
e) other separations like in ARM™ TrustZone™, in which the Secure World/Normal World respectively corresponds to the trusted/untrusted environment.
f) The general case where there is a program executor, a first set of program instructions, and a first addressable memory space to store the passwords (or other secrets) and a second set of program instructions and second addressable memory space, where the program executor assigns the first address space to the instructions in the first set, and that program executor or another one, assigns to the instructions in the second set the second addressable memory space which excludes the part of the first addressable memory space that holds the passwords. A memory protection unit such as a MMU can achieve this separation.

It's further considered the use of any kind of communication interface between the first and second environment, for example the PC can communicate with the Dock by high-frequency sound, low-frequency sound or wide-band sound, or a kernel environment can communicate with the application environment by shared memory, message passing, a function call, kernel traps or similar means for software communication.

Although the present invention has been described regarding several illustrative embodiments, numerous variations and modifications will be apparent to those skilled in the art that do not depart from the teachings herein. Such variations and modifications are deemed to fall within the purview of the appended claims.

In one possible embodiment the system prevents the second environment to receive data regarding the trusted input user interface state, by giving exclusive control to the trusted input user interface to the first computing environment. In another embodiment, the first computing environment is configured to deny access to the input device while it is requiring confirmation of a secure operation, but to allow the use of the input user interface for other non-secure operations, so the input interface can be shared between both environments without degrading security. The same distinction can be made over the output of the user interface: the output of the user interface can be shared between the first and second computing environments as long as the user is notified unambiguously and securely of which environments is controlling which part of the output interface. A considered variation is that the input interface (which has been previously secured by any of the methods described) provides a way to securely switch the output of the user interface between trusted an untrusted environments, for example, by means of pressing a dedicated button or buttons combination.

The security scheme applied to the execution of a determinate computer program can define the computing environment. The scheme typically represents the configuration of permissions given to such computer program for using the available resources in specific ways. Resources are typically storage memory and its addressable spaces, communication resources such as a memory buffer or network devices, specific information to be accessed, another executable program, and I/O devices such as (respectively) a keyboard and a display.

A permission can be granted or denied, in a static or dynamic way. A typical case of a static configuration is the one defined by a hardware architecture. In that case, a permission to use a determinate resource can be statically granted for example by providing a communication channel for allowing the computer program to access a specific I/O resource (i.e. providing a hardware connection between the processor and the device), and can be statically denied for example by the scheme of not providing such channel at the architectural level. Once the access is possible in hardware, the permissions can be further determined in software to denied the otherwise allowed permissions, an example of that is the restriction to access a specific data just in encrypted form, so only by using the key the plain text can be accessed, thus a software can have granted the permission to access a determinate secret in plain-text while other software can have the permission denied by not providing access to the decryption key. The software configuration of permissions can be enforced in a hardware-assisted why, such as achieved by memory management unit implemented in hardware in a processor, configured in software to separate memory spaces. A typical attack to steal secrets, is to run malware in a environment in which access to a memory space is delimited and granted to a whole process, in which in some small portion the secret is stored, and then malware exploit the access to the whole space to steal the password. And, since typically such process has granted access to a network resource, the secret can be communicated to a unintended party.

As examples of that permissions configuration and how to exploit them for implementing the present invention, some examples are given as follows. In the case of the password protecting embodiment, a program is run first environment with permissions to access the password in plain-text, and to network resources for communicating the password to the server, while the browser program run in a second environment where the access to the password denied. Then, the access to a cookie obtained by a login operation can be granted or denied to the browser at software level depending on a user configuration. In the two platform embodiment, access to the hardware UI used for confirmation, is entirely granted to the program running in first environment but denied to the second environment. In the embodiment comprising a display shared between the first and second environment, access to the display is granted to both environment but control of the indicator for knowing which environment is controlling the display is granted to the first environment but denied to the second environment. In the case of a input device such as a keyboard accessible to both environments at the hardware level, access is granted to the first environment to know the input device state but in some circumstances, access to know such input state is denied to the second environment, such as for example for inputting a PIN or if the input device is for selecting from which environment the data is displayed.

1. A method for interacting with a website server by means of the HTTP and SSL/TLS protocols, the website server capable of a login operation using user authentication records on the website server for checking a username and a password, the method comprising the steps of:
(a) arranging a first computing environment by securely coupling a first data processor, an user interface, a RAM memory 3 and a non-volatile memory;
(b) configuring a second computing environment for communicating with the first computing environment and for running a browser;
(c) deciding whether to perform the login operation in the first computing environment;
(d) obtaining the password from said non-volatile memory;
(e) inserting the password into an HTTP request with the first data processor;
(f) checking the website server's certificate in said first environment;
(g) establishing a login session using the SSL/TLS protocol by sending the HTTP request from the first computing environment to the website server to obtain an authentication data representative of the login session;
(h) securing the password for not revealing the password to the browser running in the second computing environment; and
(i) browsing, based on the obtained authentication data representative of the login session, the established login session with the browser;
whereby the login operation is carried in the first computing environment without leaking sensitive information and the login session is browsed taking advantage of the powerful resources of the second environment.

2. The method according to claim 1 wherein said user interface further comprises a second data processor having at least an interface for controlling at least one of 1) an input device, 2) an output device, and 3) a first wireless module.

3. The method according to claim 1 wherein the first computing environment is implemented as a first computer platform 13 including at least one of 1) the first data processor, 2) the RAM memory, and 3) the non-volatile memory.

4. The method according to claim 1 wherein the second computing environment is implemented as a second platform comprising a computer controlling a second user interface.

5. The method according to claim 1 wherein the login operation data consist essentially of the combination of said password with said username.

6. The method according to claim 3 wherein said first computing platform is transportable as part of a key-chain.

7. The method according to claim 1 wherein the deciding step (c) is based on confirming the login operation based on information comprising the website server shown in said user interface.

8. The method according to claim 1 wherein the password is a password to be remembered.

9. The method according to claim 1 wherein the browsing step (i) comprises receiving responses directly from the website server to the second environment and sending requests directly from the browser to the website server.

10. The method according to claim 1 wherein the securing the password step (h) comprises: encrypting with an obtained first SSL/TLS session key said HTTP request having inserted therein the password; and obstructing the first SSL/TLS session key to be known in the second environment.

11. The method according to claim 1 wherein for carrying the browsing step comprises obtaining in the browser a second SSL/TLS session key.

12. The method according to claim 11 wherein said second SSL/TLS key is obtained by carrying a SSL/TLS session renegotiation operation.

13. The method according to claim 1 wherein the securing step comprises controlling the software running on the first computing environment by not allowing the execution of non-authenticated software.

14. The method according to claim 1 wherein said authentication data representative of the login session comprises a first cookie.

15. The method according to claim 1 wherein the first data processor is configured for modifying the HTTP request to set the username.

16. The method according to claim 1 wherein the obtaining the password step (d) is carried by decrypting the password using a PIN entered in said user interface.

17. The method according to claim 1 wherein the obtaining the password step (d) is carried by using a password database.

18. The method according to claim 1 wherein the first data processor is configured for receiving the HTTP request from the browser.

19. The method according to claim 1 wherein the second environment is configured for running a routing software module that allows each of the first and second computing environments to make a plurality of connections to the website server and to route HTTP requests generated by the browser, depending on an evaluation, to the first computing environment or to the website server.

20. The method according to claim 19 wherein the routing software module is further configured for separately redirecting a half-duplex stream of said plurality of connections to the website server, from the first computing environment to the second computing environment.

21. The method according to claim 1 further comprising the steps of:
(a) transforming in the first computing environment said authentication data representative of the login session to obtain a transformed authentication data;
(b) securing the authentication data representative of the login session for not being revealed to the second computing environment;
(c) sending the transformed authentication data to the browser;
(d) carrying said browsing step (i) in the second computing environment basing the browsing of the established session on the transformed authentication data;
(e) obtaining in the first computing environment the authentication data representative of the login session associated to the transformed authentication data received from the browser; and
(f) inserting in the first computing environment the authentication data representative of the login session in a second request header to be sent to the website server.

22. The method according to claim 21 wherein the first data processor is configured for replacing in a response header received from the website server the authentication data representative of the login session with the transformed authentication data for obtaining a modified response header to be sent to the browser.

23. The method according to claim 21 wherein the transformed authentication data is a second cookie.

24. The method according to claim 21 wherein the step (e) of obtaining in the first computing environment the authentication data representative of the login session is based on one of 1) using an encrypted version of the authentication data representative of the login session as the transformed authentication data, and 2) using the transformed authentication data in a lookup operation.

25. The method according to claim 1, wherein the establishing a login session step (g) uses the HTTPS protocol.
